(19) United States
(12) Patent Application Publication
(10) Pub. No.: US 2026/0301312 A1
(43) Pub. Date: Oct. 1, 2026

(54) AI-Assisted Physical Asset Inspection

(71) Applicant: Aicadium Holdings Pte. Ltd., Singapore (SG)

(72) Inventors: Zi Jian Yew, Singapore (SG); Jiaxiang Ren, Irvine, CA (US); Yang Zhong, San Diego, CA (US); Bing Huan Chua, Singapore (SG); Amit Kumar Swami, Singapore (SG); Ruo Ling Poon, Singapore (SG); Joshua Jacobson, Ann Arbor, MI (US); Dimitry Fisher, San Diego, CA (US)

(21) Appl. No.: 19/631,137

(22) Filed: Mar. 27, 2026

Related U.S. Application Data
(60) Provisional application No. 63/781,256, filed on Mar. 31, 2025.

(51) Int. Cl. G06T 15/20; G06V 10/26; G06V 10/70; G06V 10/74; G06V 10/75; G06V 10/776; G06V 10/98; G06V 20/59; G06V 30/19

(52) U.S. Cl. CPC G06T 15/205; G06V 10/273; G06V 10/761; G06V 10/768; G06V 10/776; G06V 10/987; G06V 20/59; G06V 30/19013; G06V 30/19093; G06T 2200/24; G06V 10/751

(57) ABSTRACT

Certain aspects of the disclosure provide a method for performing AI-assisted physical asset inspection. In aspects, the method includes obtaining a set of reference images associated with one or more parts of a physical asset; generating a three-dimensional (3D) reconstruction of the physical asset; defining an asset coordinate system based on mapping the 3D reconstruction of the physical asset; storing, for each reference image, imaging perspective data, asset feature data, and spatial context feature data within a database; obtaining a set of inspection images; and performing an image inspection by: identifying a matching reference image for an inspection image of the set of inspection images; calculating a confidence score based on comparing the stored imaging perspective data, asset feature data, and spatial context feature data to the inspection image, wherein a status of a part of the physical asset is indicated by the confidence score.

### CROSS REFERENCE TO RELATED APPLICATION(S)

The present Application for Patent claims priority to and benefit of U.S. Provisional Patent Application No. 63/781,256, filed Mar. 31, 2025, which is hereby expressly incorporated by reference herein in its entirety.

### INTRODUCTION

### Technical Field

Aspects of the present disclosure relate to methods for performing AI-assisted physical asset inspections.

### Background

Inspection of physical assets is relied upon by organizations to ensure sufficient supplies, spare parts, and other materials are available for tasks, such as maintenance repair and operations (MRO), quality assurance (QA), dispatch and delivery, and the like. Inspections, report compilations, and certification of the results is a time-consuming process often carried out by highly-trained and skilled individuals. However, even highly-trained human inspectors may become fatigued or distracted; and fail to notice a missing or incorrectly installed part, a foreign object, or a defect, thereby resulting in inconsistent decisions between different human inspectors. Further, human inspectors are not always available, leading to scheduling challenges for an already costly and time-consuming inspection process. Accordingly, it would be advantageous to provide for improved methods of performing AI-assisted physical asset inspection.

### SUMMARY

A first aspect provides a method for performing AI-assisted physical asset inspections, the method includes: obtaining a set of reference images associated with one or more parts of a physical asset, wherein each reference image of the set of reference images corresponds to a respective imaging perspective; generating a three-dimensional (3D) reconstruction of the physical asset based on the set of reference images; defining an asset coordinate system based on mapping the 3D reconstruction of the physical asset to a coordinate frame for the asset; storing, for each reference image, imaging perspective data, asset feature data, and spatial context feature data within a database; obtaining a set of inspection images associated with the physical asset; and performing an image inspection, wherein the image inspection comprises: identifying a matching reference image for an inspection image of the set of inspection images based on calculating a similarity score between the inspection image and a reference image that satisfies an imaging perspective similarity threshold; calculating a confidence score based on comparing the stored imaging perspective data, asset feature data, and spatial context feature data associated with the matching reference image to the inspection image, wherein a status of a part of the physical asset in the inspection image is indicated by the confidence score satisfying a confidence threshold; and generating a report based on the calculated confidence score, wherein the report comprises a status indicator for the part of the physical asset.

A second aspect provides a processing system configured to perform the aforementioned method as well as those described herein; non-transitory, computer-readable media comprising instructions that, when executed by a processor of a processing system, cause the processing system to perform the aforementioned method as well as those described herein; a computer program product embodied on a computer-readable storage medium comprising code for performing the aforementioned method as well as those further described herein; and a processing system comprising means for performing the aforementioned method as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts example architecture for an AI-assisted physical asset inspection system according to one or more aspects.

FIG. 2 depicts an example process for performing an initial inspection using an AI-assisted physical asset inspection system according to one or more aspects.

FIG. 3 depicts a diagrammatic view of example fiducial markers implementable by an AI-assisted physical asset inspection system according to one or more aspects.

FIG. 4 depicts a diagrammatic view of an example asset coordinate system defined by an AI-assisted physical asset inspection system according to one or more aspects.

FIG. 5 depicts examples of annotating 3D coordinate points on reference images obtained by an AI-assisted physical asset inspection system according to one or more aspects.

FIG. 6 depicts an example table of coordinate representations for a set of reference images implemented by an AI-assisted physical asset inspection system according to one or more aspects.

FIG. 7A depicts an example subsequent inspection architecture implementable by an AI-assisted physical asset inspection system according to one or more aspects.

FIG. 7B depicts a diagrammatic view of a selection of a matching reference image for an inspection image being processed by an AI-assisted physical asset inspection system according to one or more aspects.

FIG. 8 depicts an example process for performing a subsequent image inspection implementable by an AI-assisted physical asset inspection system according to one or more aspects.

FIG. 9 depicts an example process for generating outputs implementable by an AI-assisted physical asset inspection system according to one or more aspects.

FIG. 10A depicts an example reference image obtainable during an initial inspection according to one or more aspects.

FIG. 10B depicts example inspection images obtainable during a subsequent inspection according to one or more aspects.

FIG. 10C depicts example inspection images obtainable during a subsequent inspection according to one or more aspects.

FIG. 11 depicts an example method for performing physical asset inspection implementable by an AI-assisted physical asset inspection system according to one or more aspects.

FIG. 12 depicts an example architecture for an AI-assisted physical asset inspection system.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for performing AI-assisted physical asset inspections.

Aspects described herein utilize a series of AI algorithms, user interfaces (UIs), and data pipelines, to enable partial or complete automation of the physical asset inspection. In particular, described aspects include an initial inspection for obtaining a set of reference images using a combination of 3D reconstruction and coordinate mapping, and a subsequent inspection for utilizing specific camera position and pose estimation, to compare a set of inspection images to the set of reference images using one or more image or template-matching algorithms, and Bayesian evidence aggregation.

Detection of present and missing parts during physical asset inspection has not been comprehensively addressed in practice. This is because the conventional computer-vision and machine-learning methods of performing physical asset inspection either lack the accuracy to do so reliably or require extensive training datasets to learn the visual appearance of every relevant part of a given asset. As used herein, an “asset” may refer to any physical object such as a vehicle, an engine, a building or structure, an industrial aggregate, or the like, that has a plurality of parts that are visible in the process of visual inspection, construction, and disassembly, MRO, and so on. Physical assets are usually inspected to ensure they are present, correctly installed, and free of visible defects. In addition, physical inspection may be used to confirm the absence of foreign objects or assets, incorrect installation, or defective parts. Hence, physical asset inspection is a time-consuming process currently carried out by highly-trained and skilled individuals. Physical inspection is typically carried out many times during the service life of an asset. Even a highly-skilled human inspector may become fatigued or distracted; and fail to notice a missing or incorrectly installed part, a foreign object, or a defect, thereby resulting in inconsistent decisions between different human inspectors.

Additional complexity of the task stems from the variability in the appearance of some parts: flexible wires, cables, or hoses; highly reflective or transparent parts; parts that are significantly occluded or obscured by other parts, or are difficult to access; parts that change appearance due to normal thermal, mechanical, or chemical processes; parts that may be sourced from multiple manufacturers or suppliers, or in multiple versions; partially or fully consumable or disposable parts; parts of the same or similar type appearing in multiple locations or positions; and so on. Conventional techniques often rely on complex imaging systems that may include specific scanners, sensors, or other imaging devices that can be expensive to purchase, maintain, and constantly utilize.

For conventional techniques for physical asset inspection that rely on training detectors on detecting a specific part, datasets that sufficiently capture the above-discussed features are either unavailable, impractical, or cost-prohibitive to collect. Furthermore, conventional techniques for performing physical asset inspections rely on retraining every time a part or component is changed, or a new asset is introduced into an inspection pipeline. In addition, conventional computer-vision and machine-learning methods, such as change-detection or object-detection, are not sufficiently robust to changes in camera position and pose, lighting, background, reflections, and so on; resulting in both false positives and false negatives for part presence or absence, as well as confusion between insufficiently distinct parts.

Aspects described herein provide a technical solution for the aforementioned technical problems by providing systems and methods for performing AI-assisted physical asset inspections. In particular, described aspects perform an initial inspection to obtain 3D reconstructions of a physical asset, and then map parts of the asset to an asset-coordinate system to generate a coordinate representation of the parts to be inspected. A subsequent inspection may then compare features of an inspection image including one or more parts being inspected with stored feature data of a matching reference image having a similar imaging perspective. As used herein, an “imaging perspective” refers to a point of view for a given image, such as based on one or more position, pose, lighting, background, and other similar features or settings that may affect the features or contents of an image for the purpose of comparison and matching. Matching of the imaging perspective of an inspection image to a reference image based on comparing the inspection image to stored features of the reference image can be used to ensure that the images being compared use a similar imaging perspective. In addition, described aspects may use the coordinate representation of the parts being inspected to generate a localized image by cropping out of a local image region to be inspected. This allows a physical asset to be unambiguously inspected using matching algorithms even in the presence of multiple components with the same appearance, thereby overcoming challenges posed by using conventional matching algorithms that may identify false matches based on an identical or nearly identical part being present in a different position from the region being inspected. Described aspects further utilize a set of AI algorithms for feature matching between an inspection image and a matching reference image that overcome the limitations of conventional physical asset inspection techniques by eliminating the need for extensive training on detailed and specific datasets to robustly detect both present and missing parts of a new or previously unconsidered physical asset. The initial and subsequent inspections may further be performed using a single commercially available imaging device, such as a camera or a smart device having a camera integrated therewith. Accordingly, described aspects overcome the reliance of conventional techniques that employ costly complex imaging systems including multiple scanners, sensors, and the like.

Described aspects performing AI-assisted physical asset inspections further provide for various technical benefits. As an example, described physical asset inspection systems rely on 3D reconstructions and coordinate mapping, thereby eliminating the need for extensive training when adding new physical assets to an inspection system. This provides the technical benefit of improved performance and compute efficiency due to the reduced retraining and storage requirements. In addition, the image-matching algorithms used by the physical asset inspection systems described herein compare images having similar imaging perspectives using local and global context and establish sub-pixel-level correspondence across images. This provides the technical benefit of increased precision when detecting small deviations that may be missed by conventional object detectors, and further increases robustness in handling variations in lighting, perspectives, and minor deformations. Described aspects further provide for inference times during asset inspection that are based primarily on image resolution and algorithm complexity rather than model depth and extensive training. This provides the technical benefit of improving consistency and predictability of asset inspection execution times as compared to asset inspection systems relying on neural network-based detectors having increased variability with respect to execution time.

### Example Systems and Methods for Performing AI-assisted Physical Asset Inspections

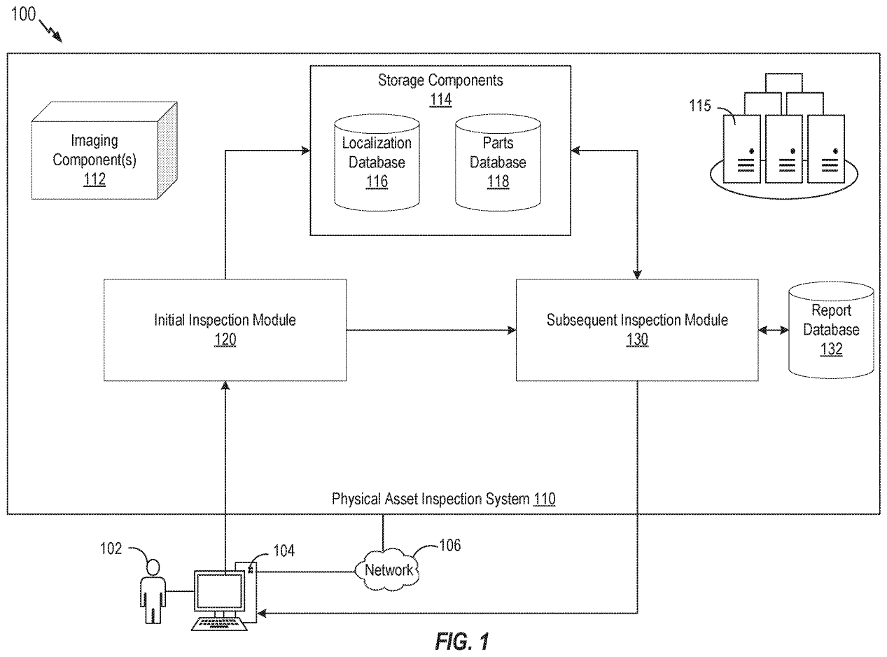

FIG. 1 depicts an example architecture 100 for an AI-assisted physical asset inspection system 110 according to one or more aspects.

Physical asset inspection system 110 may be employed as an application (e.g., hosted locally or remotely) for enabling a user to request the performance of an inspection of a physical asset to determine the status of one or more parts of the physical asset.

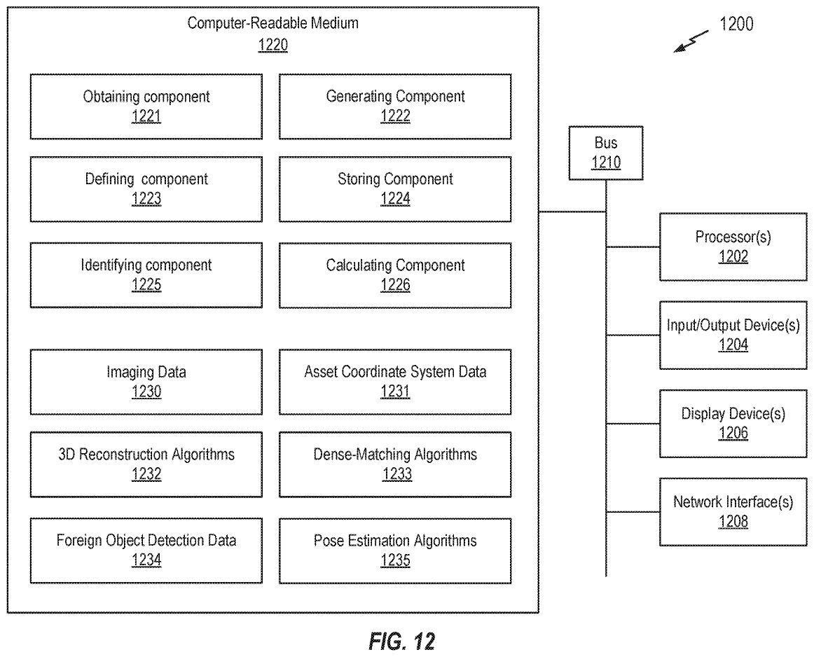

Physical asset inspection system 110 may be implemented by one or more processing systems 115, for example, corresponding to a processing system 1200 described below with reference to FIG. 12, including one or more processors and one or more non-transitory computer-readable media storing computer-readable instructions that, when executed by the one or more processors, cause the one or more processing systems to perform processes defined by computer-readable instructions corresponding to one or more components depicted and described herein.

A user 102 may interface with aspects of physical asset inspection system 110 through a device 104. In certain aspects, device 104 may be a personal computer, a tablet computer, a smart device (e.g., a smartphone), or the like. Device 104 may access physical asset inspection system 110 via any suitable network 106, including personal area networks (PANs), local area networks (LANs), wide area networks (WANs), the Internet, and the like.

In certain aspects, device 104 includes a display device for implementing a UI with the user 102, one or more processors for executing logic, and one or more non-transitory computer-readable media for storing information and/or computer-readable instructions. In certain aspects, device 104 operates as an interface for interacting with physical asset inspection system via the UI, which is provided by physical asset inspection system 110. For example, user 102 may utilize device 104 to manually request the performance of an inspection of a physical asset by submitting a request via the UI. In some implementations, device 104 is integrated or co-located with imaging component 112.

Physical asset inspection system 110 includes an initial image inspection module 120 configured to obtain and/or process a set of reference images. The set of reference images may be obtained using an imaging component 112. In certain aspects, imaging component 112 includes any device for image or video acquisition and/or recording, such as a camera. Imaging component 112 may be a standalone device or included as a part of another device, such as a smartphone, tablet, smart glasses, or the like. In some implementations, imaging component 112 is equipped with or connected to additional components, such as a light source, gimbal, boom, cables, monitors, or the like. In some examples, imaging component 112 may be configured to include multiple imaging devices that work as a coherent system of imaging devices.

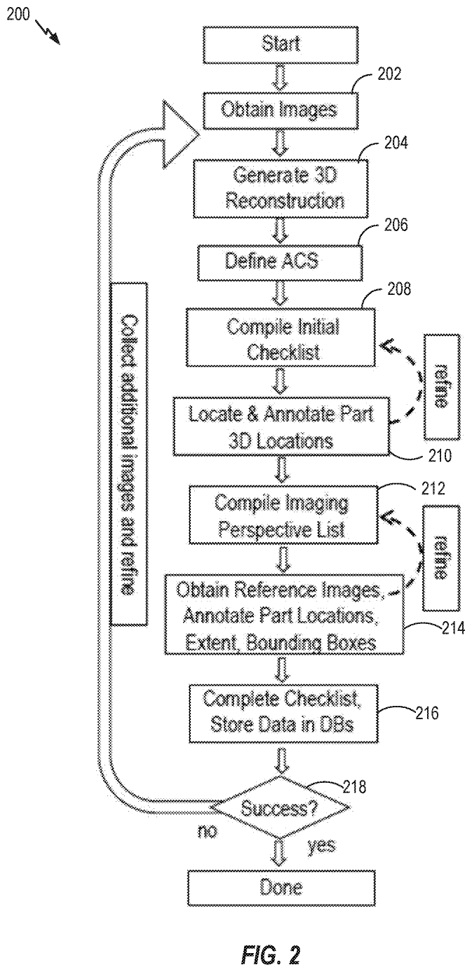

Initial image inspection module 120 is further configured to generate a 3D reconstruction of a physical asset. One or more parts of the physical asset are then mapped to an asset coordinate system to generate a coordinate representation of the parts of the physical asset. Initial image inspection module 120 is configured to store various asset features within storage components 114. Storage components 114 may include any local or cloud-based storage structures, such as a database. In this example, storage components 114 include a localization database 116 configured to store at least reference images, corresponding imaging perspectives (e.g., poses, camera positions, etc.) and 3D reconstructions of the physical assets and surrounding features. A parts database 118 may be configured to store at least coordinates for each of the parts and surrounding structures from a set of reference images and any corresponding annotated features. Initial image inspection module 120 thus obtains and/or processes a set of reference images to generate and store data usable to enable downstream matching of inspection images to the set of reference images based on various features stored within storage components 114, as is described in greater detail below with reference to example process 200 of FIG. 2.

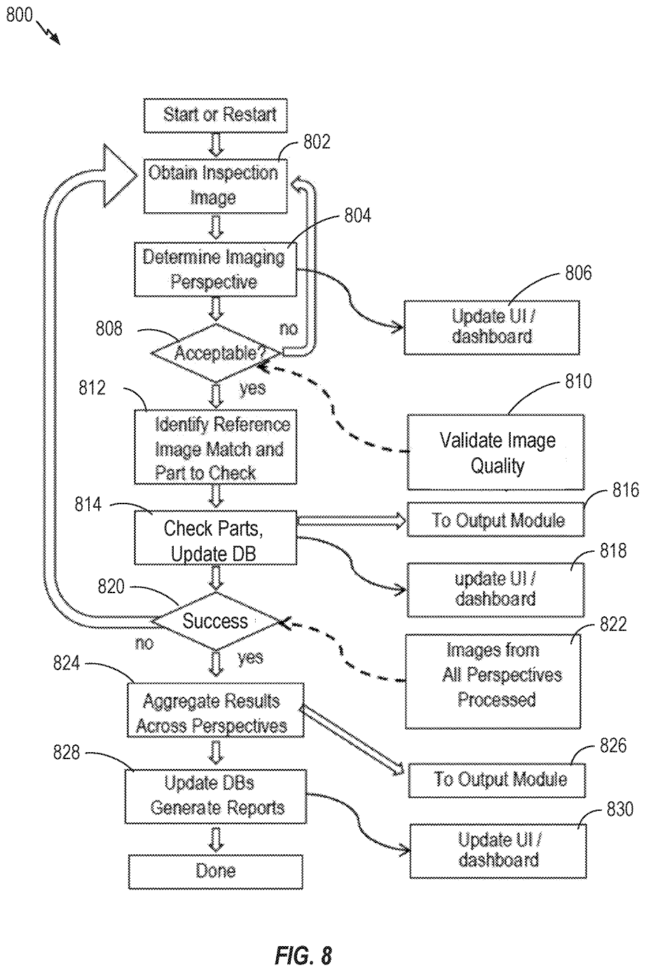

Physical asset inspection system 110 further includes a subsequent inspection module 130 configured to obtain and process a set of inspection images to perform an inspection of one or more physical assets by comparing an inspection image with a matching reference image and corresponding feature data stored within storage components 114. Subsequent inspection module 130 is configured to employ a series of AI algorithms that include image-matching algorithms (e.g., dense or semi-dense) for comparing features of an inspection image to a matching reference image to determine a status of a physical asset. For example, subsequent inspection module 130 may be configured to leverage AI when utilizing local feature transformer (LOFTR) algorithms or other deep learning-based feature-matching techniques for feature correspondences between a reference image and a subsequent inspection image to determine a status of a given asset part. As used herein, a status of a given part may refer to the given part being present, absent, damaged (e.g., has a defect), installed incorrectly, or installed correctly. The subsequent inspection module may further determine the presence of foreign objects or other anomalies. Upon completion of the inspection of a part, subsequent inspection module 130 may be configured to generate one or more reports or other documentation detailing the results of the inspection. Subsequent inspection module 130 stores generated reports within a report database 132, which may include local or cloud-based storage. The reports or other outputs detailing the results of the inspection may then be returned to user 102, such as via device 104. Subsequent inspection module 130 and examples of its implementation are described in greater detail below, such as at example process 800 with reference to FIG. 8.

FIG. 2 depicts an example process 200 for performing an initial inspection using an AI-assisted physical asset inspection system according to one or more aspects. For example, process 200 may be performed by one or more components of initial image inspection module 120 of physical asset inspection 110 described above with reference to FIG. 1.

At block 202, the physical asset inspection system collects images. For example, images may be obtained using one or more imaging components, for example, using imaging components 112 with reference to FIG. 1. In aspects, the physical asset inspection system may employ imaging devices configured to utilize various imaging modalities, such as visible light, lidar, radar, sonar, thermal imaging, UV, X-ray, and the like.

The images collected at block 202 include a set of reference images (sometimes referred to as “template images”) for a given physical asset and its corresponding surrounding structures. Here, the terms “template image” and “reference image” are used interchangeably to refer to an image of a physical asset, which may include one or more parts, and its surroundings that has been acquired in the process of the initial inspection and/or catalogued for reference in the subsequent inspections, as explained in greater detail below. As used herein, a “part” refers to any component or constituent of a given physical asset. As used herein, a “segment” refers to any section of a given part.

A reference image may capture a given area of a physical asset. As used herein, an “area” refers to any region of a given asset, including, but not limited to, a section of an asset surface or a section of asset interior as observed through an opening, possibly containing one or more parts and corresponding segments.

During initial inspection, the number of images acquired may be larger than the number of images acquired during subsequent inspections. That is because the subsequent stages of the initial inspection (namely, 3D reconstruction, establishing and mapping the asset coordinate system, and camera position and pose planning) include camera positions, poses, and settings that would not be used for the subsequent inspections. In aspects, the image acquisition is carried out using the imaging device (e.g., camera and lens) that will be used on the subsequent inspections. In some examples, the physical asset inspection system may utilize imaging devices for obtaining images from videos. Imaging devices of various makes and models may be used, provided they have adequate framerate, resolution, and optics quality (low distortions, aberrations, diffraction).

In certain aspects, in addition to employing a first imaging device, such as a camera, described physical asset inspection systems may further utilize a second imaging device during initial inspection. For example, described aspects may further employ a 360-degree or “fisheye” camera to acquire a full view of the asset and its environment from various positions around the asset to facilitate visualization and 3D reconstruction of the asset.

In some examples, the reference images at block 202 are obtained via an automated imaging capture process, such as by using a conveyor belt, autonomous vehicle, drone, robot, or other autonomous mechanism to capture reference images based on video or images of a mapped environment, including a set of fixed positions for capturing images. In other examples, the reference images are obtained manually by receiving a set of reference images provided by a user interacting with a provided UI via a display of a device, such as on device 104 described above with reference to FIG. 1. In some aspects, a list including a parts checklist and/or inspection instructions (e.g., inspection manual) may be provided to the physical asset inspection system prior to use during the initial inspection when capturing a set of reference images for one or more parts of the physical asset.

In some examples, the initial inspection may be carried out in stages, for example, when partial disassembly of the asset occurs, and/or when the list and sequence of camera poses and positions, as well as the parts checklist and reference images, are compiled iteratively. In other examples, multiple repetitions of the initial inspection may be necessary, as explained above. In some cases, reference images of the same part are obtained from multiple fixed positions (e.g., vantage points). This allows better visualization of one or more parts of a given asset, to increase the confidence of determination of whether the part is present, correctly installed, and free of defects. It further enables visualization of multiple segments of the same part, e.g., when the part is not fully visible in any single image. This is particularly useful for inspection of elongated parts such as tubes, pipes, cables, wires, long structural or functional elements, parts that are partially occluded by overlaying parts or structures, and so on.

In some examples, flexible parts such as cables or wires pose a particular challenge for the initial (or subsequent) inspection, as their exact shape and position relative to other parts is not well constrained. For example, a given wire or cable may have the ability to flex or translate when parts move. Described aspects overcome these challenges by specifically detecting the components or part segments that are fixed, including segments adjacent to connectors, fairings, bushings, brackets, and other fixed structural or functional elements. As mentioned above, such parts are imaged and detected by described aspects in multiple segments, and from one or more vantage points, to increase the confidence of determination of whether the part is present, correctly installed, and free of defects.

At block 204, the physical asset inspection system generates 3D reconstructions of the physical asset based on the obtained set of reference images. In certain aspects, the physical asset inspection system generates the 3D reconstruction using one or more algorithms, which may include structure from motion algorithms and multi-view stereo algorithms, to generate 3D point clouds or mesh models. In other examples, the physical asset inspection system utilizes radiance field methods, such as Neural Radiance Fields or Gaussian Splatting, to generate 3D models using either point clouds or 3D Gaussian splats. For example, utilizing Neural Radiance Fields may involve employing a trained neural network for mapping 3D coordinates and viewing directions to color and density values, such as by optimizing a volumetric representation by learning how light interacts at different points in space. Gaussian splatting may be used to generate a 3D reconstruction of a physical asset using a collection of Gaussian functions for rendering complex surfaces with soft blending by projecting the Gaussians onto an image plane. In some cases, Gaussian Splatting may improve visualization due to improved visual quality, and explicit point clouds/meshes for precise 3D measurements (e.g., ray casting). In some aspects, the 3D reconstruction can also be generated from 3D data acquired from specialized 3D scanning devices using 3D registration methods. In other examples, the physical asset inspection may further include specialized 3D scanning devices, such as a combination of one or more of photogrammetry-based scanners, structured light scanners, or light detection and ranging (LiDAR) scanners, or the like. Such 3D scanning devices may be included within available imaging components, such as imaging components 112 described above with reference to FIG. 1. In certain aspects, image features and 2D-3D correspondences are also estimated during a Structure from Motion process. For example, structure from motion processes may perform feature detection and matching by identifying key points across multiple views, estimating relevant imaging perspectives, and computing 3D points via triangulation by intersecting rays from multiple camera views to form 2D-3D correspondences. These features are then stored for use during subsequent inspection processes to recover the camera's imaging perspective (e.g., pose, position, orientation, and the like) from which a given reference image is taken. For example, the image features and estimated 2D-3D correspondences may be stored within storage components 114 as described above with reference to FIG. 1.

When generating the 3D reconstructions from the reference images, a metric scale can be recovered and/or its accuracy can be improved. This metric scale is useful because the 3D reconstruction is often generated based on calculating relative distances between certain points without any external references for scale. In some aspects, the physical asset inspection system is configured to utilize fiducial markers as reference objects placed in a given image to help establish a metric scale and improve accuracy during 3D reconstruction of the physical asset or one or more surrounding structures.

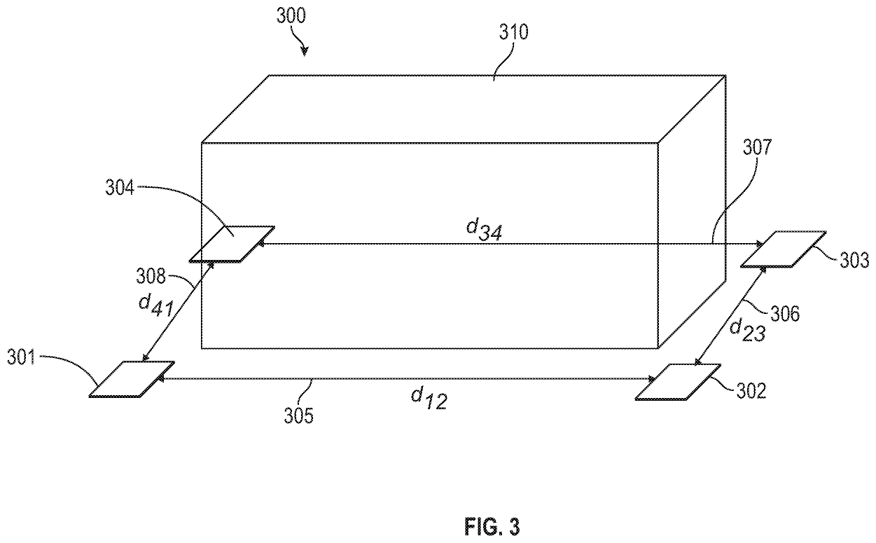

FIG. 3 depicts a diagram 300 including example fiducial markers implementable by a physical asset inspection system according to one or more aspects. The general approach for recovering the metric scale discussed above is to make use of known object sizes. However, it can be challenging to pinpoint 3D points precisely due to point cloud sparsity. Accordingly, the physical asset inspection system may be configured to leverage multiple fiducial markers, contained within reference images, having a known distance between them. As used herein, “fiducial markers” refer to reference points usable in computer vision and 3D reconstruction to provide scale. Fiducial markers are placed in an environment prior to capturing reference images. The fiducial markers may be a printed pattern (e.g., QR code, checkerboard, AprilTag, ArUco markers or the like) with known dimensions or a ruler or scale bar for measurement reference. The fiducial markers can be precisely localized in a given reference image and subsequently in the 3D reconstructed model. For example, in diagram 300, a first fiducial marker 301, a second fiducial marker 302, a third fiducial marker 303, and a fourth fiducial marker 304 are positioned around a physical asset 310. There is a defined and measurable distance between each of the fiducial markers 301-304. For example, a distance d₁₂ at 305 represents the distance between fiducial marker 301 and fiducial marker 302. Similarly, d₂₃ at 306, d₃₄ at 307, and d₄₁ at 308 represent the distance between fiducial marker 302 and 303, 303 and 304, and 304 and 301, respectively. The fiducial markers thus provide an absolute reference for scaling, thereby improving the accuracy of 3D reconstruction and alignment and resolving scale drift or ambiguity in large environments.

Returning to process 200 of FIG. 2, at block 206, the physical asset inspection system defines an Asset Coordinate System (ACS). For example, the coordinate representation will include a defined position and orientation for one or more parts of a physical asset and its surrounding structures, such as defined by an X, Y, and Z coordinate for a coordinate frame created for a physical asset. Other coordinate systems (such as cylindrical, for example) may be utilized as the ACS or along with the ACS, with an appropriate mapping established to convert the locations (coordinates) from one coordinate system to another. Likewise, for poses and orientations of objects (asset parts, camera, and imaging perspective, etc.) in the ACS, the spatial orientation coordinates or representations (such as quaternions, Euler angles, Tait-Bryan, or roll-pitch-yaw rotation angles) are used and stored. In other aspects, quaternions may be used. In some examples, for objects located on a flat surface (e.g., floor, wall, working surface) or objects constrained to rotation around one axis only (e.g., nuts, bolts, clips, brackets, covers), specifying a single rotation angle is sufficient for performing the described aspects.

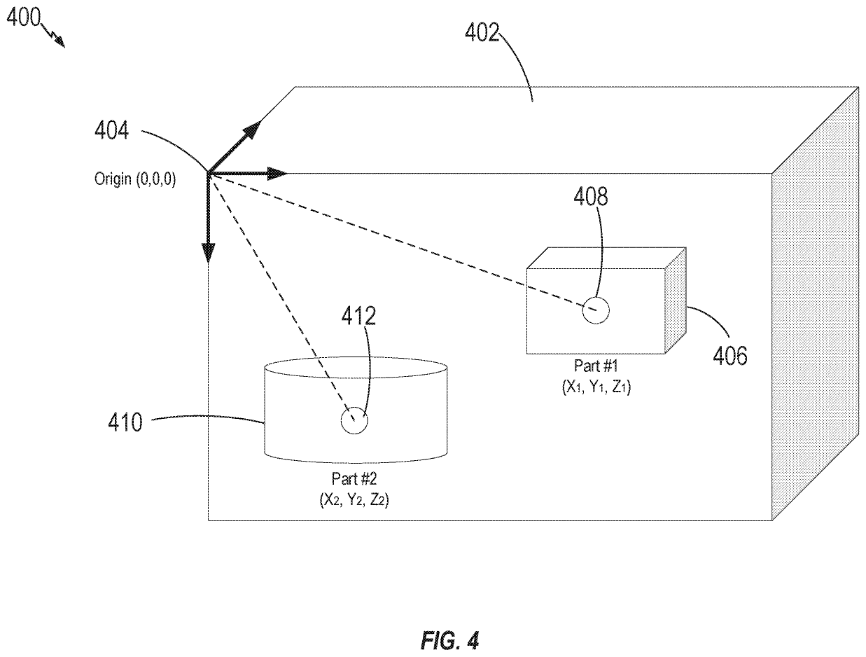

FIG. 4 depicts a diagram 400 including an example asset coordinate system defined by an AI-assisted physical asset inspection system according to one or more aspects. Described aspects use the generated 3D reconstruction model to define the ACS with respect to a prominent invariant point on the physical asset being inspected, rather than a point in the scene. For example, the invariant point may be associated with an estimated geometric center of a physical asset being inspected, or an easy to identify fixed feature (e.g., a mounting bracket, a distinct edge, a welding point, or the like). The invariant point may be determined using structure from motion techniques described above, for example, employed by an initial inspection module, such as the initial image inspection module 120 described above with reference to FIG. 1. This improves accuracy for scenarios where the inspected physical asset may not be at the same location all the time. The initial inspection module may further utilize structure from motion techniques to determine all camera poses used for obtaining reference images, as well as locations of inspected parts, which are defined in the ACS. In diagram 400, an example physical asset 402 is being inspected by a physical asset inspection system as described herein. The physical asset inspection system defines an ACS based on an origin point 404 positioned at coordinates (0,0,0) on each of the X, Y, and Z axes. Described aspects may then use the defined ACS to generate a coordinate representation of the physical asset by mapping the 3D reconstruction to the defined ACS, as will be described in greater detail below at block 210 of process 200. In diagram 400, a first part 406 of physical asset 402 has a center 408 with a defined coordinate representation of (X₁, Y₁, Z₁), while a second part 410 has a center 412 with a defined coordinate representation of (X₂, Y₂, Z₂).

At block 208, the physical asset inspection system compiles or acquires an initial checklist. The initial checklist may include one or more physical assets to be inspected, a list of reference images to be compiled for each part and corresponding imaging perspective data (e.g., camera poses, camera settings, camera orientation, etc.), the generated 3D reconstructions from block 204, and other features related to a physical asset and its corresponding reference images as may be useful for gathering data to enable subsequent inspections.

At block 210, the physical asset inspection system locates and annotates parts of physical assets (such as based on the initial checklist) and their 3D locations. For example, described aspects may generate a coordinate representation of each part to be inspected for a given physical asset that includes a defined X, Y, and Z position based on the defined ACS, such as described above with respect to 408 and 412 of FIG. 4. In some examples, the coordinate representation of the 3D reconstruction can further be localized in an image frame, enabling cropping out of a local image region to be inspected. This allows a physical asset to be unambiguously inspected using dense-matching algorithms even in the presence of multiple components with the same appearance, thereby overcoming challenges posed by using conventional matching algorithms that may identify false matches based on an identical or nearly identical part being present in a different position from the region being inspected.

At block 212, the physical asset inspection system compiles an imaging perspective list including each of the imaging perspectives to be used for subsequent inspection of each part of the physical asset in the initial list. The imaging perspectives may include camera position, orientation, settings, and the like.

At block 214, the physical asset inspection system acquires reference images, annotates parts locations, extents, and bounding boxes for each of the parts to be inspected. In some cases, parts labeling may be carried out during or after the 3D reconstruction of the asset. For example, reference images containing parts to be inspected (e.g., based on the initial checklist) may be manually annotated with 2D bounding boxes or polygons that indicate the location and span of each part. Likewise, a 3D extent of each part may be annotated. For some parts, multiple segments and/or multiple views may be annotated, for example by using multiple bounding boxes and/or multiple reference images and/or multiple imaging perspectives.

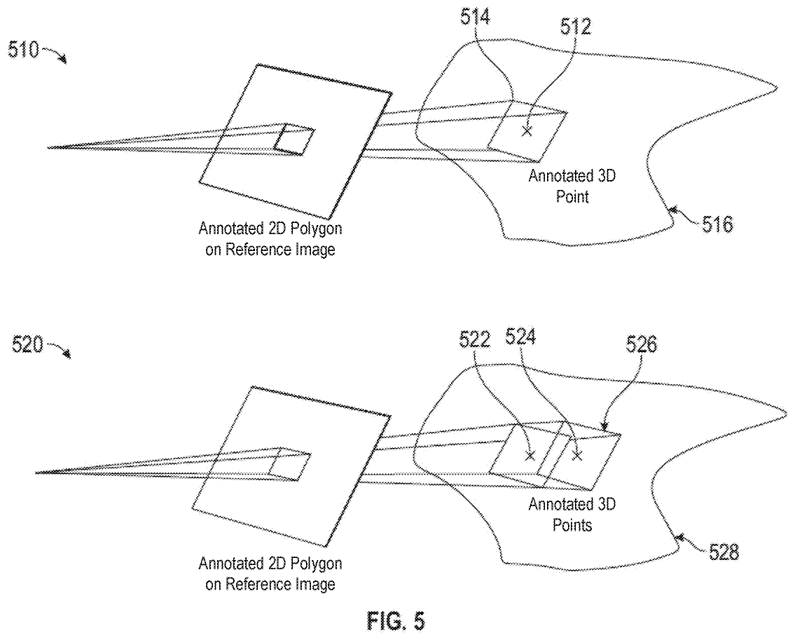

FIG. 5 depicts an example of annotating 3D coordinate points on reference images obtained by an AI-assisted physical asset inspection system according to one or more aspects. The annotated parts on the reference images may be used as samples for comparison during subsequent inspections, such as described below with reference to example process 800 of FIG. 8. Thus, the reference images should be taken at a similar imaging perspective (e.g., viewpoint) as the subsequent inspections to minimize viewpoint differences that may affect inspection accuracy. In some examples, the full 3D extent of the part (e.g., enclosed by a 3D bounding box or polygon) is annotated. In other examples, the parts location can be represented as a single or two 3D points, which can be used to unproject the 2D bounding box/polygons on the reference images into a 3D patch or bounding polygon. As used herein, “unprojecting” refers to a process of finding 3D coordinates of a point that is projected onto a 2D image plane.

In a first example 510, an annotated 2D polygon on a reference image 516 is unprojected into a 3D planar patch 514 via a single annotated 3D point 512.

In a second example 520, two annotated points 522, 524 are expanded into a 3D polygon 526 of a reference image 528. Such 3D patches or polygons can be projected into a camera frame to locate a part of a physical asset on an inspection image during subsequent inspection. For example, 2D features of an inspection image may be matched with projected 3D polygons to determine the status of a given part based on alignment and feature-matching between the projected features and the features of the inspection image.

Returning to block 214 of process 200, the physical asset inspection system may acquire bounding boxes for each reference image being considered. In aspects, the reference image for a part may be accompanied by a contour, mask, or bounding box that denotes or illustrates the separation (e.g., visual boundary) between the part proper and its immediate surroundings. This contour may be used to facilitate confidence scoring during subsequent inspection, as will be described in greater detail below. For example, a match in the surroundings location, but not at a location of the part itself, is a strong indication that the part is absent or incorrectly installed at its intended location.

In some examples, the initial inspection module of the physical asset inspection system may further include an optical character recognition (OCR) component for performing OCR and processing the corresponding data. As such, block 214 may, in some examples, further include the physical asset inspection system identifying alphanumeric information in an inspection image, and then performing OCR to read, record, register, confirm, or validate corresponding data. The data may include, for example, a serial number and/or other alphanumeric information, barcodes, QR-codes, etc., on certain parts or locations of the asset. This data may then be stored within databases (e.g., within storage component 114 as described above with reference to FIG. 1) to provide additional features for comparison during subsequent inspection. To enable this functionality, images of parts acquired during the inspection are passed to an OCR module. The OCR module may be configured to detect text and then perform OCR on the detected text. In aspects, the image passed to the OCR module is cropped and/or masked, for example, as the part is detected, to apply the OCR algorithm specifically to the area of the detected part (or its immediate vicinity). The purpose of such cropping or masking is to ascertain that the information on the part proper is read by the OCR module, and to avoid the OCR module reading information not pertaining to the said part.

At block 216, the physical asset inspection system then completes the lists by compiling all of the data from the previous blocks into one or more databases, for example, using storage components 114 described above with reference to FIG. 1. As an example, the physical asset inspection system may store and leverage imaging perspective data, asset feature data, and spatial context feature data for each reference image associated with a given checklist within a database. As used herein, “imaging perspective data” may include camera position, orientation, pose, lighting conditions, exposure settings, camera type, configuration data, and the like. As used herein, “asset feature data” may include data associated with one or more parts being inspected, such as 3D model and extracted feature data for one or more parts of an asset, coordinate data for the one or more parts of the physical asset, template images associated with the one or more parts (including any annotated data), and the like. As used herein “spatial context feature data” refers to any features and data associated with surrounding parts positioned near a part of an asset being inspected (and their relative locations). Surrounding parts include any nearby parts to one or more parts being inspected, such as within a shared reference image.

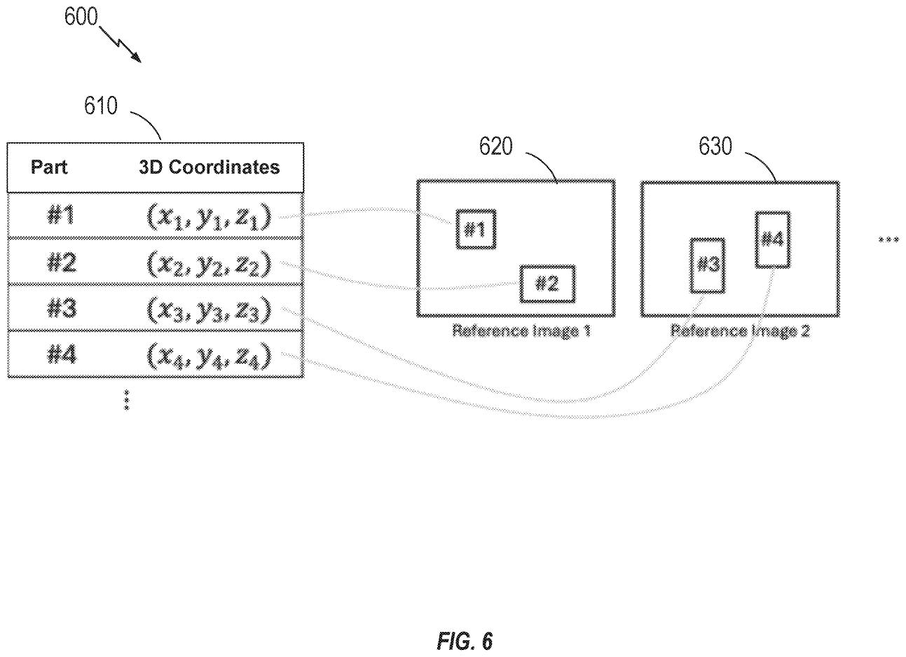

FIG. 6 depicts an example 600 of coordinate representations for a set of reference images implemented by an AI-assisted physical asset inspection system according to one or more aspects. The data in example 600 includes coordinate representation for parts from multiple reference images. The coordinate representations may be stored as asset data within a database of the physical asset inspection system. In example 600, a table 610 includes a list of parts with respective identifiers. Each part may be assigned any alphanumeric identifier. As shown, table 610 includes a series of sequentially numbered parts having corresponding 3D coordinates including an X, Y, and Z coordinate value. In table 610, a first part #1 and a second part #2 correspond to two parts of a first reference image 620, while a second part #3 and a third part #4 correspond to a second reference image 630.

Returning to FIG. 2, at block 218, the physical asset inspection system determines whether the initial inspection was successful based on whether the data for the initial checklist from block 208 has been obtained (e.g., sufficient reference images and corresponding image perspective data, asset feature data, and spatial context feature data). If the data has been obtained and stored, the initial inspection is complete. If there is data or reference images missing, the process will return to block 202 to obtain additional reference images and corresponding data.

The stored imaging perspective data, asset feature data, and spatial context feature data for each reference image are used during subsequent image inspection to perform image-matching (e.g., dense or semi-dense matching) to enable precise and accurate inspections of one or more parts of a given physical asset. As used herein, “image-matching” refers to a technique for comparing two images by aligning pixels based on extracted features and then comparing discrepancies between established aligned pixels of the two images for a given end use, such as change detection, object recognition, or the like. Because described aspects rely on obtaining 3D reconstructions and coordinate mapping of parts within reference images to enable downstream performance of image-matching (such as described at process 800 with reference to FIG. 8), the need for extensive training when adding a new physical asset to be inspected (e.g., when using conventional trained-detector techniques for physical asset inspection) is eliminated, thereby providing the technical benefit of improved performance and compute efficiency due to the reduced retraining and storage requirements.

Once the physical asset inspection system has obtained all of the reference images and stored corresponding data, a subsequent inspection process may be performed, for example, using a subsequent inspection module. Subsequent inspections are normally carried out when an asset is due for inspection, e.g., on receipt, dispatch, delivery, maintenance, repair, upgrade, certification, and so on. The inspection checklist including inspection waypoints with corresponding camera positions and poses in the asset coordinate system and reference images (templates) of the asset parts acquired during the first inspection(s) are available at the start of a subsequent inspection.

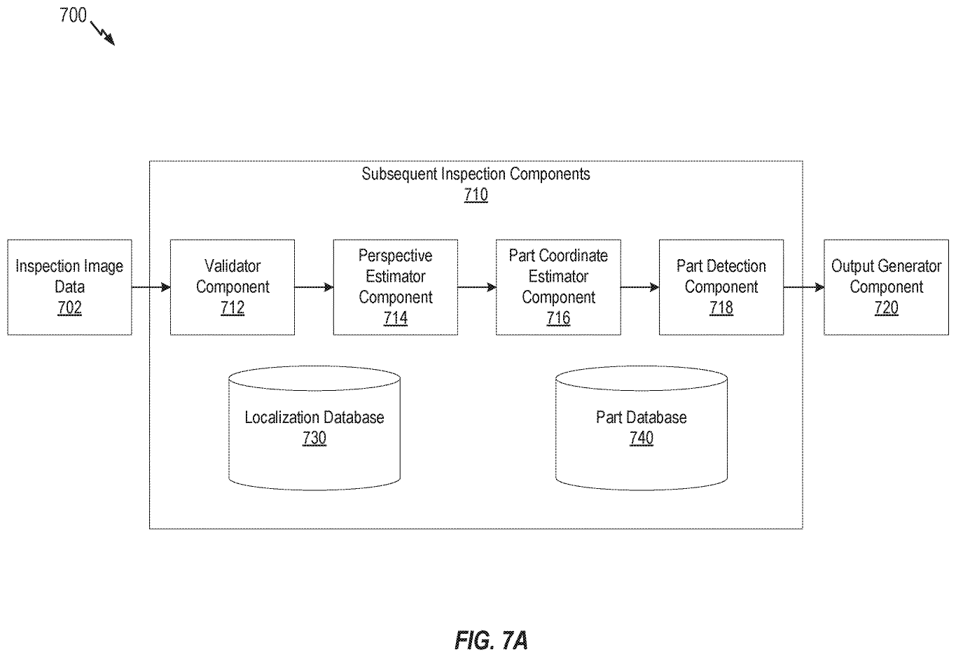

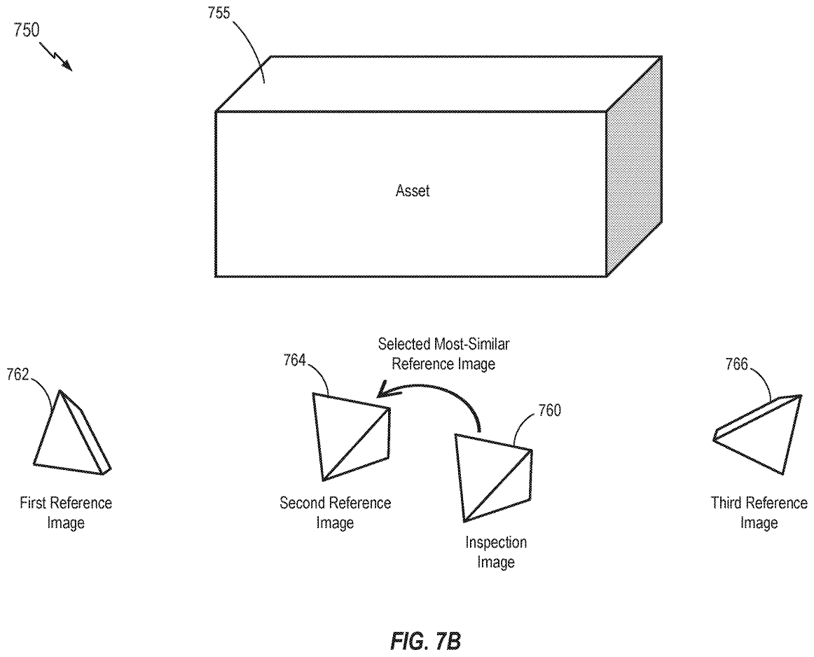

FIG. 7A depicts an example subsequent inspection architecture 700 implementable by an AI-assisted physical asset inspection system according to one or more aspects. Subsequent inspection architecture 700 includes subsequent image inspection components 710, which may be implemented by an example subsequent inspection model, such as subsequent inspection module 130 described above with reference to FIG. 1.

Subsequent inspection architecture includes a validator component 712 configured to receive inspection image data 702. Inspection image data 702 may include a current image or target image to be used during a subsequent inspection. As used herein, “current image” or “target image” refer to the image of an expected part location, and in some cases its surroundings, that is acquired in any subsequent inspection with the goal to determine whether the part (or each one of the plurality of parts) is present or absent, whether it is installed correctly or not, and/or whether it is free of visible defects. Inspection image data 702 may further include image metadata, such as prior estimates of camera poses (if available) and camera intrinsic data, such as image format, focal length, pixel size, principal point (optical center) data, and the like.

In some examples, a set of inspection images may be received as individual frames having accompanying metadata. The metadata can further include a prior estimate of the camera pose, if available. The camera pose estimate can come from various sources, such as an external positioning system, fixed pre-programmed robot waypoints (in the case of a robot-based inspection system), a camera pose of a previous frame (in the case of a continuous video), or the like. If no prior camera pose is available, the camera pose may be estimated using relocalization algorithms. Example relocalization algorithms may include fast appearance-based mapping algorithms, relocalization in visual simultaneous localization and mapping (SLAM) algorithms, dense SLAM algorithms, point cloud registration algorithms, and the like.

Once validator component 712 receives an inspection image data 702, it performs an image validation process. For example, validator component 712 may perform checks regarding image sharpness, image exposure, and white balance. In some cases, validator component 712 may be configured to employ an image quality testing algorithm to determine whether the acquired images are of adequate quality for parts detection and/or other operations of the described methods. The image quality testing algorithm may be used both in the initial and in the subsequent inspections. Examples of inadequate quality may include, but are not limited to, an over or underexposed image, an image that is out of focus, an image with a depth-of-field that is too narrow, an image taken with an incorrect color balance, presence of dirt, occlusions, an image with many image artifacts, and the like. The validator component 712 may generate an image quality score using the employed algorithm. In some examples, if the generated image quality score is below a threshold, the physical asset inspection system may generate and send a notification to a user to obtain an additional inspection image, thereby filtering out low-quality inspection images to increase precision and accuracy of inspections.

Validator component 712 may then provide the validated image and quality metrics to a perspective estimator component 714.

Perspective estimator component 714 is configured to estimate one or more of a camera position, pose, and/or orientation by matching the validated inspection image against stored imaging perspective data. For example, the perspective estimator component 714 may compare an inspection image against imaging perspective data within a localization database 730. The physical asset inspection system may be configured to utilize one or more algorithms for estimating the camera position, pose, and/or orientation of a given inspection image for inspecting a given part of a physical asset. In some examples, the physical asset inspection system may utilize local feature matching with transformers (LoFTR) or Efficient LoFTR algorithms configured to find a first area in an inspection image that approximately matches (corresponds to) a second area associated with a part of interest in a corresponding reference image (e.g., the expected part location and its surroundings). For example, the LoFTR algorithm may identify a bounding box, mask, or region in a stored reference image that corresponds to a part of interest, such as based on a set of matched pixel coordinates corresponding to the camera's field of view of perspective. The perspective estimator component 714 is thus usable to detect a matching reference image for a given inspection image, such as based on calculating a similarity score between the inspection image and a reference image that satisfies a threshold. In some examples, to facilitate such comparison and scoring, as well as to provide visual feedback to the user, the physical asset inspection system may further be configured to apply 2D or 3D transformations (mapping, such as homography or photogrammetry) to overlay the contour from the reference image onto the target image. As discussed above, such contours may be used to facilitate the confidence scoring and to display confidence scores in the provided UI. For example, a match in the surroundings location but not in the part location is a strong indication that the part is absent or incorrectly installed at its intended location. The applied transformation may be calculated from the best match identified by the LoFTR and/or other image matching algorithm(s).

FIG. 7B includes a diagram 750 that depicts an example selection of a matching reference image for a given inspection image that is being processed by an AI-assisted physical asset inspection system according to one or more described aspects. As an example, the selection of the matching reference image depicted in diagram 750 may be performed by an example AI-assisted physical asset inspection system implementing architecture substantially similar to the subsequent inspection architecture 700 of FIG. 7A.

In particular, diagram 750 includes an asset 755 that is the target of a subsequent inspection process being performed by an AI-assisted physical asset inspection system according to certain aspects described herein. The AI-assisted physical asset inspection system may implement an example perspective estimator component, such as in accordance with perspective estimator component 714 depicted and described above with reference to FIG. 7A, to estimate one or more of a camera position, pose, and/or orientation of a given part associated with an inspection image 760 by detecting a matching reference image. Notably, the inspection image 760 is associated with a given part corresponding to the asset 755 that is the target of the inspection. The AI-assisted physical asset inspection system calculates similarity scores between the inspection image 760 and a set of reference images including a first reference image 762, a second reference image 764, and a third reference image 766. As an example, the AI-assisted physical asset inspection system may calculate a similarity score between inspection image 760 and the second reference image 764 that satisfies a defined threshold, thereby causing the AI-assisted physical asset inspection system to select the second reference image 764 as a match for the inspection image 760. Notably, estimating one or more of a camera position, pose, and/or orientation of the part associated with inspection image 760 by matching the inspection image 760 against stored imaging perspective data allows for improved accuracy in downstream determinations to identify a presence or absence of the part, an installation status of the part, or any defects associated with the part.

In some aspects, perspective estimator component 714 may further employ structure-from-motion pose estimation algorithms to reconstruct or recover the actual camera positions and poses from which the images were taken, relative to the asset, and/or validate that the camera positions and poses are within the acceptable tolerances from the set of inspection imaging perspectives within the checklist, such as established during the initial inspection. The structure-from-motion pose estimation algorithms may be utilized in near-real time during the inspection. When a deviation is detected from a prescribed waypoint, the physical asset inspection system may provide an alert or signal to the user to correct the camera positions and pose or retake the inspection image as required.

After determining the imaging perspective for the received inspection image, a part coordinate estimator component 716 is configured to estimate image coordinates of components in the inspection image that should be checked for during the subsequent inspection. For example, a first “part 1” detected in a given matching reference image may be associated with a specific coordinate representation including an X, Y, and Z coordinate position stored within accessible databases, such as described above with reference to the table 610 with reference to FIG. 6, that includes a stored coordinate representation for each part within the matching reference image. For example, the stored coordinate representations for the parts of the reference image may be stored within parts database 740. This allows the asset inspection system to confirm which parts in each image should be checked.

A part detection component 718 then determines whether the part is present by comparing the features of the inspection image to stored imaging perspective data, asset features data, and spatial context features data for corresponding matching reference images taken from a similar perspective. Part detection component 718 may utilize the LoFTR algorithms to check matching coordinates in the inspection image. Employed LoFTR algorithms may include one or more algorithms represented by a family of dense and/or semi-dense image matching algorithms that can match the part location between the template (reference) image and the inspection image both when the part is present, defect-free, and correctly installed; and when the part is missing, incorrectly installed, and/or defective. This is because such image-matching algorithms use not only the features of the part proper, but also its spatial context features (e.g., features of the part's surroundings, and their relative locations). For example, the LoFTR algorithms may evaluate features related to geometric overlap (e.g., to evaluate presence of a part), shifts or rotations in position of the part (e.g., indicative of misalignment), features related to texture, edges, or patterns of a part as compared to a corresponding feature of the part in the matching reference image (e.g., to detect damage or alteration), and the like. For example, to detect defects, the LoFTR algorithm may be used to identify discrepancies between an inspection image and a matching reference image that indicate surface deformations, cracks, or missing parts, or surface texture changes, such as based on geometrical misalignments or distortions, mismatched or absent features, or discolorations. As discussed above, the image-matching algorithms used by the physical asset inspection system at block 814 compare image features and high-resolution details rather than using learned patterns such as relied upon by conventional trained detectors. This provides the technical benefit of increased precision when detecting small deviations that may be missed by conventional object detectors, and further increases robustness in handling variations in lighting, perspectives, and minor deformations.

In some examples, additional feature-matching algorithms are used, alone or in conjunction with LoFTR-type algorithms, to generate, improve, or refine the match, as well as to evaluate and improve the confidence of part presence or absence, the confidence of defect detection, and/or the confidence of correct/incorrect part installation.

In aspects, part detection component 718 may further be configured to detect foreign objects in, on, or in the immediate vicinity of the asset being inspected. During a visual inspection, different types or categories of foreign objects may be encountered. Example categories for detection of foreign objects are discussed below.

A first example category includes asset parts that are installed at incorrect locations, installed in disagreement with the parts checklist (e.g., contrary to the required configuration of the asset), or installed but not declared in the asset documents. In some examples, this category of the foreign objects is detected using the matching algorithms described above. For example, if part A should not be present at a specific location or plurality of locations, positive detection of part A at any of the said locations constitutes/triggers the positive Foreign Object detection.

A second example category of foreign objects includes items or parts that should not be present, however, are expected to be occasionally found: such as work tools and materials, outdated or unsuitable versions or models of some parts, common debris such as rivets or metal shavings, wrapping materials, and so on. In some implementations, some or all of those may be included in the initial checklist as parts that should not be present; or in a separate section of the checklist specifically dedicated to the known foreign objects. In some implementations, the physical asset detection system may further include an additional detection component, such as a convolutional neural network (not shown) that is usable to detect some or all of these foreign objects in the images.

A third example category of foreign objects includes items or parts that are not normally expected to be encountered and are thus omitted from the checklist. Similarly, systems that rely on training detectors are typically not trained on such items or parts. Detecting the objects in this category is sometimes referred to as an “open-world” or “open-dictionary” detection problem. In aspects, the physical asset detection system may be configured to employ one or both methods of open-dictionary foreign object detection elaborated below.

In a first example method of the open-dictionary foreign object detection, the physical asset inspection system may utilize change-detection and anomaly-detection algorithms. When the appearance of a certain area of the asset does not match the reference images, or does not match what is normally expected in the segment of the asset, there is an increased likelihood that an unknown foreign object (or defect) may be present. In aspects, the physical asset inspection system generates an alert, noted in the UI and/or inspection report, to the relevant personnel (e.g., inspector) or software (e.g., ERP).

In a second example method of the open-dictionary foreign object detection, the physical asset inspection system may be configured to employ foundation models, such as large vision models. Such a model may either be used as-is, or fine-tuned (for example, on the views of the asset or assets inspected in the past). Such a model may be instructed to list or find objects in some or all of the images, or to describe them in some way. This may be done whether in a single-agent or in agentic AI settings (using multiple models and/or human in the loop, interacting with each other, or in parallel). For example, in a single-agent setting, the foundational model may operate as a central system for performing inspection tasks autonomously. In agentic AI settings, the foundational model may work collaboratively, sharing information and tasks to perform inspections. Business logic or another Foundation Model (e.g. LLM) may be used to then determine, for each such object list or verbal description, whether it is consistent or not with the normal appearance of the asset. When it is deemed inconsistent with the normal appearance of the asset, this generates an alert, is noted in the UI and/or inspection report, or is otherwise communicated by the present invention to the relevant personnel (e.g., inspector) or software (e.g., ERP).

For many types of assets, the three categories of foreign objects may overlap and/or be present simultaneously. For example, an inspection image may include parts in incorrect locations and one or more foreign objects present. Accordingly, the methods described above for detection of foreign objects of either one of the three categories may be used interchangeably or across multiple categories of foreign objects, non-exclusively to mitigate increased risk of misclassification in the presence of multiple categories.

In other examples, part detection component 718 may further leverage stored OCR data, such as obtained during initial inspection at block 214 described above with reference to process 200 of FIG. 2. When a part is not detected, and/or when the confidence for part presence or absence is relatively low, then stored OCR data can also be used as a secondary means of part detection. When the part information could be read by the OCR module at the part's intended location in the image(s), this data is used as additional evidence that the part is indeed present. In some implementations, when the part information was not found or read by the OCR module at the part's intended location in the image(s), this data is used by the physical asset inspection as additional evidence that the part is indeed absent or incorrectly installed.

Part detection performed by part detection component 718 using one or more of the algorithms or methods described above enables the physical asset inspection system to calculate one or more confidence scores for determining a status of a given part. For example, having determined estimated image coordinates corresponding to the part of the physical asset being inspected and the one or more surrounding structures of the inspection image (e.g., based on identifying the matching reference image having corresponding data stored within an accessible database), part detection component 718 can execute one or more image-matching algorithms to compare the stored imaging perspective data, asset feature data, and spatial context feature data of the matching reference image with the inspection image based on comparing the estimated image coordinates of the part in the inspection image with the previously generated (and stored) coordinate representation of the part in the matching reference image. Part detection component 718 may utilize a LoFTR-type algorithm to calculate a normalized confidence score based on the comparison. For example, part detection component 718 may calculate a normalized confidence score of 0.9 (where 1 indicates certainty of a status) that a particular part is present within an inspection image. Calculated confidence scores related to part detection performed by part detection component 718 may be reported as one overall confidence score, and in other implementations as separate confidence scores.

Once part detection component 718 has made a determination regarding the status of a part in the inspection image, an output is generated by an output generator component 720. Output generator component 720 may be configured to generate and provide a user of the physical asset inspection system with a variety of outputs, such as a report indicating the status of each inspected part.

FIG. 8 depicts a process 800 for performing a subsequent image inspection implementable by an AI-assisted physical asset inspection system according to one or more described aspects. For example, process 800 may be performed using subsequent inspection architecture 700 described above with reference to FIG. 7A.

At block 802, the physical asset inspection system collects an image. The image at block 802 refers to an inspection image for determining the status of a part being inspected. In some examples, the physical asset system may receive one or more inspection images that are manually provided by a user. In other examples, in which an automated imaging system is utilized, the physical asset inspection system may be configured to generate a checklist including a set of inspection imaging perspectives to be obtained that correspond to the respective imaging perspectives of stored reference images, such as based on the previously provided initial checklist. The physical asset inspection system may then obtain the set of inspection images in accordance with the generated checklist.

At block 804, the physical asset inspection system determines a relevant camera imaging perspective. For example, the imaging perspective could correspond to a camera viewpoint associated with a collected reference image. Block 804 may be performed, for example, using similar means as described above with reference to perspective estimator component 714 with reference to FIG. 7A.

At block 806, the physical asset inspection system may update a UI with the relevant camera viewpoint from block 804.

At block 808, the physical asset inspection system determines whether the inspection image quality is acceptable. Block 808 includes validating image quality at block 810, for example, using similar means as performed by validator component 712 described above with reference to FIG. 7A. If the image quality is insufficient, the process may return to block 802 to collect a new inspection image. For example, the physical asset inspection system may generate and provide a notification to a user via the UI to instruct the user to obtain a new inspection image. If the image quality is acceptable (e.g., sufficient based on a threshold), then process 800 proceeds to block 812.

At block 812, the physical asset inspection system determines what parts in the inspection image should be checked. For example, the physical asset inspection system may first determine an estimated imaging perspective for the inspection image using similar means as described above with respect to perspective estimator component 714 with reference to FIG. 7A. The physical asset inspection system then estimates what parts in the inspection image should be checked using similar means as described above with respect to part coordinate estimator component 716 with reference to FIG. 7A. For example, the physical asset inspection system detects a matching reference image for a given inspection image, such as based on calculating a similarity score between an inspection image and a reference image that satisfies a threshold through the use of one or more dense-matching, image-matching, or template-matching algorithms.

At block 814, the physical asset inspection system checks each part and provides updated data (based on the checks) to accessible databases. For example, the physical asset system may check each part using similar means as described above with respect to part detection component 718 with reference to FIG. 7A.

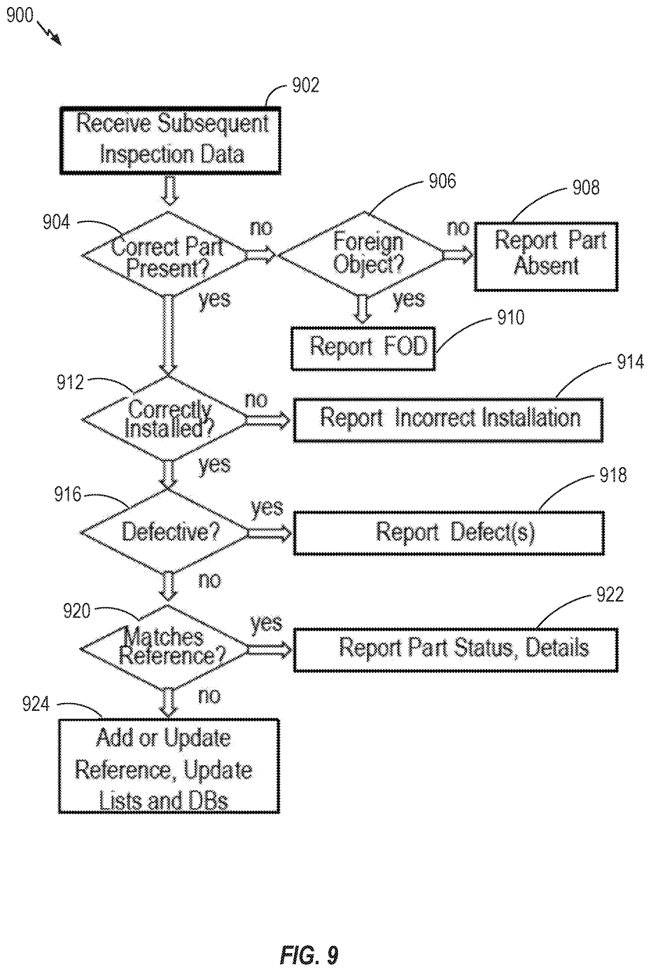

At block 816, the data obtained from block 814 is provided to an output module for generating various outputs to provide to the user to indicate the status of the checked parts. An example process performable by an output module is described in greater detail below with reference to process 900 of FIG. 9.

At block 818, the physical asset inspection system updates the UI or dashboard provided to the user with generated outputs.

At block 820, the physical asset inspection system determines whether the subsequent inspection was successful. If the subsequent inspection was not successful, the physical asset inspection system returns to block 802 to collect a new inspection image. If the subsequent inspection was successful, such as based on determining the status of the parts and associated imaging perspectives being inspected with sufficient confidence at block 822, then physical asset inspection system proceeds to block 824.

Process 800 further includes a mechanism for enabling the physical asset inspection to aggregate subsequent inspection results across multiple viewpoints. In some examples, a given part (or segments thereof) may be imaged from multiple viewpoints or checked for presence and/or correctness of installation and/or defects across multiple images.

Accordingly, at block 824, the physical asset inspection system aggregates results across multiple viewpoints, such as by using one or more aggregation algorithms. For example, an illustrative part “A” may be detected or classified as present with confidences P_{Ai}, P_{Aj} in an image or plurality of images i, j, and not detected (e.g., classified as absent) with confidences M_{Ak}, M_{Am}, in an image or plurality of images k, m, . . . where the part A should be present. The physical asset inspection system may then use one or more aggregation algorithms, triggered once all the images have been processed, or at least all the images where the part A ought to be present have been processed. The aggregation algorithm may be executed for each part independently (in parallel or sequentially), or, in some implementations, with an account for interdependence across parts. This may be used to improve accuracy and precision by considering more comprehensive datasets.

In some implementations, the aggregation algorithm is of a winner-takes-all type, comparing the largest confidence P_{A} for part “A” over images to the largest confidence M_{A} for part “A” over images, and returning “part is present with confidence P_{A}” when the largest P_{A} exceeds the largest M_{A}, or “part is absent with confidence M_{A}” otherwise. In some cases, the physical asset inspection system may utilize an aggregation algorithm of a Boolean “AND” or “OR” type where: to be deemed present, the part should be detected as present in all images (“AND”), or at least in one image (“OR”). In some aspects, the physical asset inspection system is configured to utilize a Bayesian evidence aggregation, such as by converting the aforementioned confidences into conditional probabilities of part being present or absent. In aspects, the Bayesian prior for part “A” being present or absent is derived from historical data. In other aspects, an aggregation algorithm accounts for utility (such as relative importance or relative cost) of false-positive vs. false-negative for the presence of the part. Aggregation for a decision whether a part is installed correctly, and aggregation for the decision whether a part is free of defects, may be carried out in a likewise manner, such as by using aggregated confidence scores to evaluate a status of one or more parts of a physical asset.

Aggregation algorithms discussed above are provided as a way of example, and not as an exhaustive list. Those skilled in the art may apply custom or novel aggregation algorithms in the workflow of the present invention.

In some aspects, multiple instances or versions of the algorithms used to check for part presence and/or correctness of installation and/or defects can be applied in parallel, enabling aggregation across instances or versions of the algorithms carried out as explained above.

In some examples, different images (e.g., images acquired from different viewpoints) may contain different segments of a part. In other examples, all segments of a part are detected for the part to be deemed present. In yet another example, detection of one or few segments is sufficient for the part to be deemed present, as may be accounted for in an applied aggregation algorithm. In some aspects, software flags are set to use “AND” or “OR” or “Bayes” algorithms depending on whether different images provide views of different segments of a part, or different views of the same segment of a part, or different views of the part as a whole. This is done for some or all parts and may be carried out during or after the first inspection; and in other instances, later on when sufficient data has been acquired to make an improved decision.

At block 826, data gathered from block 824 may be passed to an output module for generating various outputs to provide to the user to indicate a status of the checked parts.

At block 828, the physical asset inspection system updates the accessible databases with the data gathered during process 800 and provides generated reports (or other outputs) to update the UI at block 830.

FIG. 9 depicts an example process 900 for generating outputs implementable by an AI-assisted physical asset inspection system according to one or more aspects. For example, process 900 may be performed by an output generator component, such as output generator component 720 described above with reference to FIG. 7A. The output generator component is provided with the relevant part detection data obtained from the subsequent inspection process. Accordingly, process 900 resembles a decision tree that may be navigated based on the subsequent inspection process data.

At block 902, the output generator component receives subsequent inspection data. For example, the output generator component may receive subsequent inspection data including calculated confidence scores for a given part being inspected. The subsequent inspection data for a given part may be obtained, for example, by checking for each part by comparing an inspection image with a matching reference image, using similar means as described above with respect to part detection component 718 with reference to FIG. 7A.

At block 904, the output generator component determines whether the correct part is present based on the received subsequent inspection data.

At block 906, in response to determining that the correct part is not present, the output generator component determines if the subsequent inspection data indicates that a foreign object is present. If no foreign object is present, the output generator component will generate a report at block 908 including a status indicator that indicates the absence of any foreign objects. If the data indicates a foreign object is present, the output generator component will generate a report at block 910 including a status indicator that indicates the presence of foreign object.

At block 912, the output generator component determines if the inspection data indicates that the part was correctly installed. If the part is incorrectly installed, the output generator component generates a report indicating the incorrect installation at block 914.

At block 916, the output generator component determines if the inspection data indicates that the part is defective. If the part is defective, the output generator component generates a report indicating the defect at block 918.

At block 920, the output generator component determines if the part matches a reference (such as a stored reference image) based on a calculated similarity score satisfying a threshold. If the part matches a reference image, the output generator component generates a report indicating the status of the part and any associated details at block 922.

At block 924, the output generator component adds or updates references, and updates lists and databases with data associated with the outputs generated throughout process 900.

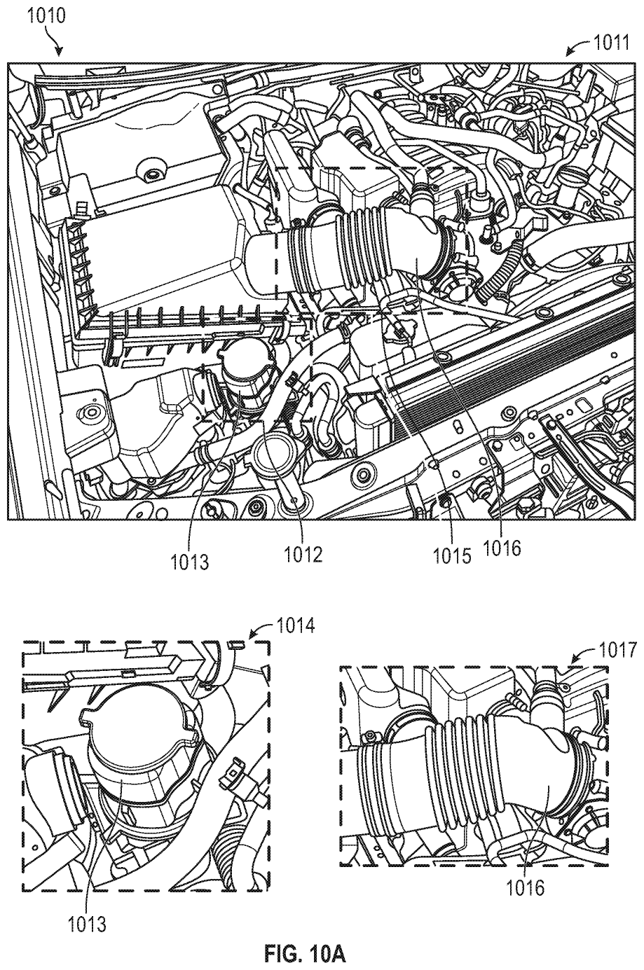

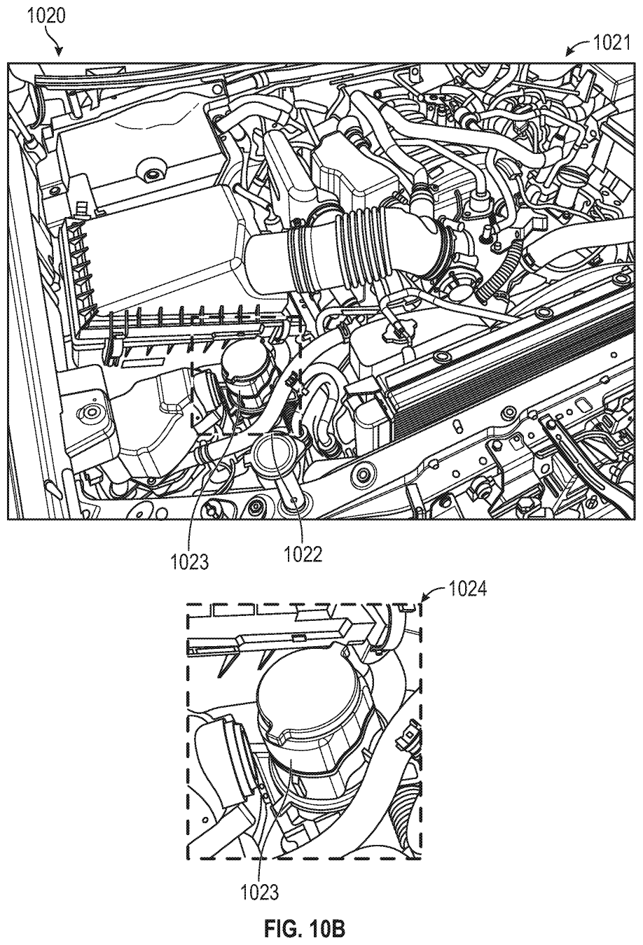

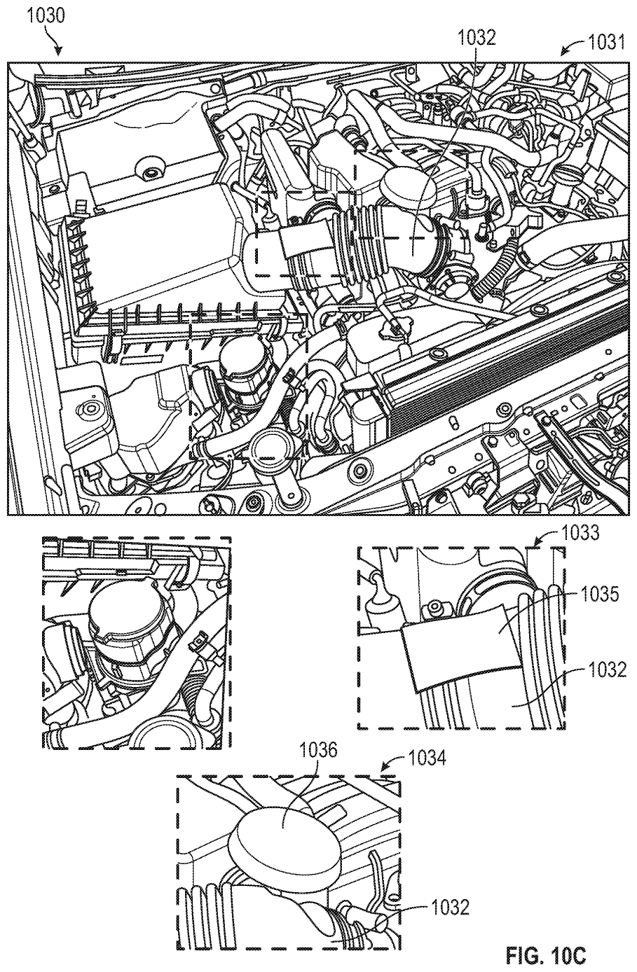

FIGS. 10A-10C depict example images obtained and utilized by described aspects for performing an inspection of one or more parts of a physical asset.

FIG. 10A depicts an example 1010 including a reference image 1011 obtainable during an initial inspection. For example, the initial inspection may be performed using similar means as process 200 described above with reference to FIG. 2. Reference image 1011 includes a first bounding box 1012 positioned around a first part 1013 corresponding to a steering fluid reservoir that is further depicted in a localized image 1014. Reference image 1011 further includes a second bounding box 1015 around a second part 1016 corresponding to an engine intake hose that is further depicted in a localized image 1017.

FIG. 10B depicts an example 1020 including an inspection image 1021 that is obtained and used for performing a subsequent inspection. For example, the subsequent inspection may be performed using similar means as process 800 described above with reference to FIG. 8. Inspection image 1021 includes a bounding box 1022 around a part 1023 corresponding to a steering fluid reservoir. During subsequent inspection, the physical asset inspection system compares the part in the inspection image 1021 with a corresponding part in a matching reference image, such as by comparing inspection image 1021 with reference image 1011 of FIG. 10A to determine a status of part 1023. For example, the physical asset inspection system may determine that part 1023 is incorrectly installed based on the differences between the images (e.g., by employing above-described image-matching algorithms to compare discrepancies between established aligned pixels of the respective images). As shown in localized image 1024, part 1023 includes a steering fluid reservoir with a cap that is quarter-turned to an open position. The physical asset inspection system may then generate an output indicating that part 1023 has been incorrectly installed, for example, by performing process 900 described above with reference to FIG. 9 to generate a report for returning to a user.

FIG. 10C depicts an example 1030 including an inspection image 1031 that is obtained and used for performing a subsequent inspection. For example, the subsequent inspection may be performed using similar means as process 800 described above with reference to FIG. 8. For example, a part 1032 corresponding to an engine intake hose may be matched to an engine intake hose of a matching reference image, such as second part 1016 of reference image 1011 depicted in FIG. 10A. As shown in localized image 1033, 1034, the inspection image 1031 depicts part 1032 including a first foreign object 1035 and a second foreign object 1036 positioned on or near part 1032 that were not present in reference image 1011 depicted in FIG. 10A. During subsequent inspection, the physical asset inspection system may determine the presence of these foreign objects by employing the above-described image-matching algorithms to compare discrepancies between established aligned pixels of the respective images. The physical asset inspection system may then generate an output indicating that part 1032 includes foreign objects on or around the part, for example, by performing process 900 described above with reference to FIG. 9 to generate a report for returning to a user.

### Example Method for Performing Ai-assisted Physical Asset Inspection

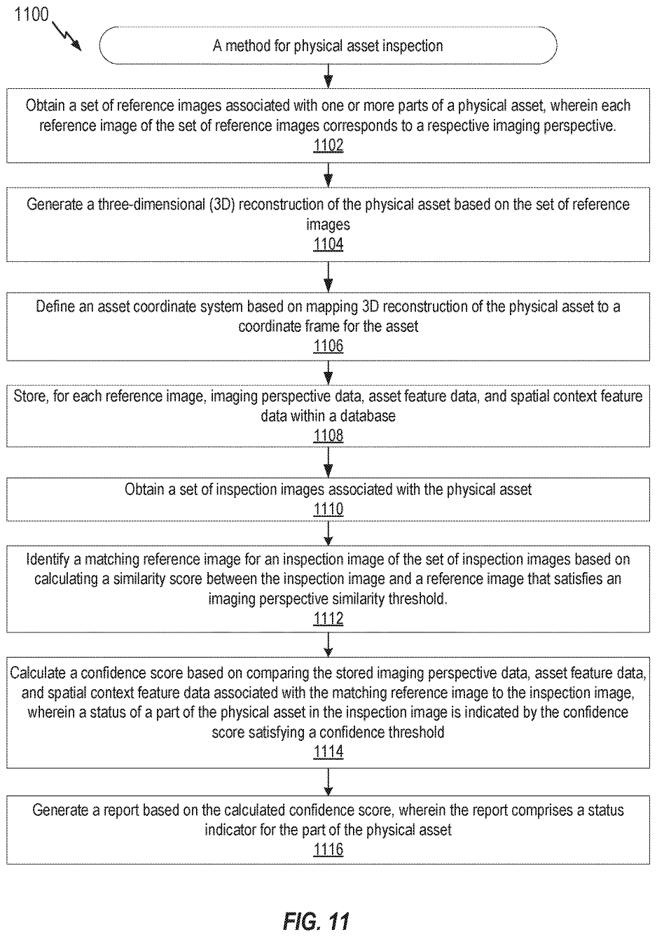

FIG. 11 depicts an example method 1100 for performing AI-assisted physical asset inspection according to one or more aspects shown and described herein.

Method 1100 begins at block 1102 with obtaining a set of reference images associated with one or more parts of a physical asset, wherein each reference image of the set of reference images corresponds to a respective imaging perspective. For example, block 1102 may be performed by the one or more processing systems 1200 described below with reference to FIG. 12, configured to implement components including, but not limited to, an obtaining component 1221 for performing corresponding processes, for example, corresponding to block 202 of process 200 described above with reference to FIG. 2.

Method 1100 proceeds to block 1104 with generating a three-dimensional (3D) reconstruction of the physical asset based on the set of reference images. For example, block 1104 may be performed by the one or more processing systems 1200 described below with reference to FIG. 12, configured to implement components including, but not limited to, a generating component 1222 for performing corresponding processes, for example, corresponding to block 202 of process 200 described above with reference to FIG. 2.

Method 1100 proceeds to block 1106 with defining an asset coordinate system based on mapping the 3D reconstruction of the physical asset to a coordinate frame for the asset. For example, block 1106 may be performed by the one or more processing systems 1200 described below with reference to FIG. 12, configured to implement components including, but not limited to, a defining component 1223 for performing corresponding processes, for example, corresponding to block 206 of process 200 described above with reference to FIG. 2.

Method 1100 proceeds to block 1108 with storing, for each reference image, imaging perspective data, asset feature data, and spatial context feature data within a database. For example, block 1108 may be performed by the one or more processing systems 1200 described below with reference to FIG. 12, configured to implement components including, but not limited to, a storing component 1224 for performing corresponding processes, for example, corresponding to block 216 of process 200 described above with reference to FIG. 2.

Method 1100 proceeds to block 1110 with obtaining a set of inspection images associated with the physical asset. For example, block 1110 may be performed by the one or more processing systems 1200 described below with reference to FIG. 12, configured to implement components including, but not limited to, an obtaining component 1221 for performing corresponding processes, for example, corresponding to block 802 of process 800 described above with reference to FIG. 8.

Method 1100 proceeds to block 1112 with identifying a matching reference image for an inspection image of the set of inspection images based on calculating a similarity score between the inspection image and a reference image that satisfies an imaging perspective similarity threshold. For example, block 1112 may be performed by the one or more processing systems 1200 described below with reference to FIG. 12, configured to implement components including, but not limited to, an identifying component 1225 for performing corresponding processes, for example, corresponding to block 812 of process 800 described above with reference to FIG. 8.

Method 1100 proceeds to block 1114 with calculating a confidence score based on comparing the stored imaging perspective data, asset feature data, and spatial context feature data associated with the matching reference image to the inspection image, wherein a status of a part of the physical asset in the inspection image is indicated by the confidence score satisfying a confidence threshold. For example, block 1114 may be performed by the one or more processing systems 1200 described below with reference to FIG. 12, configured to implement components including, but not limited to, a calculating component 1226 for performing corresponding processes, for example, corresponding to block 814 of process 800 described above with reference to FIG. 8.

Method 1100 proceeds to block 1116 with generating a report based on the calculated confidence score, wherein the report comprises a status indicator for the part of the physical asset. For example, block 1116 may be performed by the one or more processing systems 1200 described below with reference to FIG. 12, configured to implement components including, but not limited to, a generating component 1222 for performing corresponding processes, for example, corresponding to block 828 of process 800 described above with reference to FIG. 8.

In some aspects, method 1100 further includes determining estimated image coordinates corresponding to the part of the physical asset and one or more surrounding structures of the inspection image; and executing one or more image-matching algorithms to compare the stored imaging perspective data, asset feature data, and spatial context feature data of the matching reference image with the inspection image based on comparing the estimated image coordinates with the matching reference image.

In some aspects, method 1100 further includes generating a localized inspection image by cropping a portion of the inspection image.

In some aspects, method 1100 further includes validating the inspection image by determining an image quality score; and, in response to the image quality score being below a threshold, generating a notification to a user to obtain an additional inspection image.

In some aspects, method 1100 further includes generating a checklist comprising a set of inspection imaging perspectives corresponding to the respective imaging perspectives of the reference images; and obtaining the set of inspection images in accordance with the checklist.

In some aspects, method 1100 further includes identifying within a reference image, alphanumeric information for the one or more parts of the physical asset; performing optical character recognition (OCR) to obtain data associated with the alphanumeric information; and storing the alphanumeric information within storage.

In some aspects, method 1100 further includes aggregating a set of calculated confidence scores based on comparing asset features and spatial context features of the set of inspection images with their respective matching reference images; and executing one or more aggregation algorithms to determine a status of the one or more parts of the physical asset based on the aggregated confidence scores.

In some aspects, method 1100 further includes generating a set of fiducial markers having a predetermined distance between each fiducial marker, wherein the set of fiducial markers are associated with a metric scale of the 3D reconstruction.

In some aspects, method 1100 further includes identifying, using a local feature transformer algorithm, one or more discrepancies between the inspection image and the reference image, wherein the one or more discrepancies indicate one or more of a surface texture change, a surface deformation, or a missing feature associated with the part of the physical asset in the inspection image; and in response to identifying the one or more discrepancies between the inspection image and the reference image, detecting a defect associated with the part.

In some aspects, the asset coordinate system of method 1100 is defined with respect to an invariant point on the physical asset, and the invariant point on the physical asset is associated with one or more of an estimated geometric center of the physical asset or a selected fixed feature on the physical asset.

Method 1100 thus provides technical solutions to overcome shortcomings of conventional techniques for performing physical asset inspection. Method 1100 enables accurate and efficient inspection of one or more parts of a physical asset by leveraging data extracted based on generated 3D reconstructions and coordinate mapping, thereby eliminating the need for extensive training when adding new physical assets to an inspection system. This provides the technical benefit of improved performance and compute efficiency due to the reduced retraining and storage requirements. In addition, method 1100 performs asset inspection by comparing image features and high-resolution details rather than relying on learned patterns. This provides the technical benefit of increased precision when detecting small deviations that may be missed by conventional trained object detectors, and further increases robustness in handling variations in lighting, perspectives, and minor deformations.

FIG. 11 is just one example of a method, and other methods including fewer, additional, or alternative steps are possible consistent with this disclosure.

### Example Processing System for Performing AI-Assisted Physical Asset Inspections

FIG. 12 depicts an example processing system 1200 configured to perform various aspects described herein, including, for example, a method for performing physical asset inspection as described above with respect to FIG. 11.

Processing system 1200 may generally include an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 1200 includes one or more processors 1202, one or more input/output devices 1204, one or more display devices 1206, one or more network interfaces 1208 through which processing system 1200 is connected to one or more networks (e.g., a local network, an intranet, the Internet, or any other group of processing systems communicatively connected to each other), and a computer-readable medium 1220. In the depicted example, the aforementioned components are coupled by a bus 1210, which may generally be configured for data exchange amongst the components. Bus 1210 may be representative of multiple buses, while only one is depicted for simplicity.

Processor(s) 1202 are generally configured to retrieve and execute instructions stored in one or more memories, including local memories like computer-readable medium 1220, as well as remote memories and data stores. Similarly, processor(s) 1202 are configured to store application data residing in local memories like the computer-readable medium 1220, as well as remote memories and data stores. More generally, bus 1210 is configured to transmit programming instructions and application data among the processor(s) 1202, display device(s) 1206, network interface(s) 1208, and/or computer-readable medium 1220. In certain embodiments, processor(s) 1202 are representative of one or more central processing units (CPUs), graphics processing units (GPUs), tensor processing units (TPUs), accelerators, and other processing devices.

Input/output device(s) 1204 may include any device, mechanism, system, interactive display, and/or various other hardware and software components for communicating information between processing system 1200 and a user of processing system 1200. For example, input/output device(s) 1204 may include input hardware, such as a keyboard, touch screen, button, microphone, speaker, and/or other device for receiving inputs from the user and sending outputs to the user.

Display device(s) 1206 may generally include any sort of device configured to display data, information, graphics, user interface elements, and the like to a user. For example, display device(s) 1206 may include internal and external displays such as an internal display of a tablet computer or an external display for a server computer or a projector. Display device(s) 1206 may further include displays for devices, such as augmented, virtual, and/or extended reality devices. In various embodiments, display device(s) 1206 may be configured to display a graphical user interface.

Network interface(s) 1208 provide processing system 1200 with access to external networks and thereby to external processing systems. Network interface(s) 1208 can generally be any hardware and/or software capable of transmitting and/or receiving data via a wired or wireless network connection. Accordingly, network interface(s) 1208 can include a communication transceiver for sending and/or receiving any wired and/or wireless communication.

Computer-readable medium 1220 may be a volatile memory, such as a random access memory (RAM), or a nonvolatile memory, such as nonvolatile random access memory (NVRAM), or the like. In this example, computer-readable medium 1220 includes an obtaining component 1221, a generating component 1222, a defining component 1223, a storing component 1224, an identifying component 1225, and a calculating component 1226.

Obtaining component 1221 may be configured to perform processes, for example, corresponding to block 202 of process 200 described above with reference to FIG. 2. Obtaining component 1221 may further be configured to perform processes, for example, corresponding to block 802 of process 800 described above with reference to FIG. 8.

Generating component 1222 may be configured to perform processes, for example, corresponding to block 204 of process 400 described above with reference to FIG. 4. Generating component 1222 may further be configured to perform processes, for example, corresponding to block 828 of process 800 described above with reference to FIG. 8.

Defining component 1223 may be configured to perform processes, for example, corresponding to block 206 of process 200 described above with reference to FIG. 2.

Storing component 1224 may be configured to perform processes, for example, corresponding to block 216 of process 200 described above with reference to FIG. 2. Storing component 1224 may further be configured to perform processes, for example, corresponding to blocks 814 and 828 of process 800 described above with reference to FIG. 8.

Identifying component 1225 may be configured to perform processes, for example, corresponding to block 812 of process 800 described above with reference to FIG. 8.

Storing component 1224 may be configured to perform processes, for example, corresponding to block 216 of process 200 described above with reference to FIG. 2. Storing component 1224 may further be configured to perform processes, for example, corresponding to blocks 812 and 828 of process 800 described above with reference to FIG. 8.

Calculating component 1226 may be configured to perform processes, for example, corresponding to block 814 of process 800 described above with reference to FIG. 8.

In this example, computer-readable medium 1220 also includes imaging data 1230, asset coordinate system data 1231, 3D reconstruction algorithms 1232, image-matching algorithms 1233, foreign object detection data 1234, and pose estimation algorithms 1235.

The processing system 1200 may be implemented in various ways. For example, the processing system 1200 may be implemented within on-site, remote, or cloud-based computing devices.

The processing system 1200 is just one example, and other configurations are possible. For example, in alternative aspects, aspects described with respect to the processing system 1200 may be omitted, added, or substituted for alternative aspects.

### Example Clauses

Implementation examples are described in the following numbered clauses:

Clause 1: A method comprising: obtaining a set of reference images associated with one or more parts of a physical asset, wherein each reference image of the set of reference images corresponds to a respective imaging perspective; generating a three-dimensional (3D) reconstruction of the physical asset based on the set of reference images; defining an asset coordinate system based on mapping the 3D reconstruction of the physical asset to a coordinate frame for the asset; storing, for each reference image, imaging perspective data, asset feature data, and spatial context feature data within a database; obtaining a set of inspection images associated with the physical asset; and performing an image inspection, wherein the image inspection comprises: identifying a matching reference image for an inspection image of the set of inspection images based on calculating a similarity score between the inspection image and a reference image that satisfies an imaging perspective similarity threshold; calculating a confidence score based on comparing the stored imaging perspective data, asset feature data, and spatial context feature data associated with the matching reference image to the inspection image, wherein a status of a part of the physical asset in the inspection image is indicated by the confidence score satisfying a confidence threshold; and generating a report based on the calculated confidence score, wherein the report comprises a status indicator for the part of the physical asset.

Clause 2: The method of Clause 1, wherein calculating the confidence scores further comprises: determining estimated image coordinates corresponding to the part of the physical asset and one or more surrounding structures of the inspection image; and executing one or more image-matching algorithms to compare the stored imaging perspective data, asset feature data, and spatial context feature data of the matching reference image with the inspection image based on comparing the estimated image coordinates with the matching reference image.

Clause 3: The method of Clause 2, further comprising: generating a localized inspection image by cropping a portion of the inspection image.

Clause 4: The method of any one of Clauses 1-3, further comprising: validating the inspection image by determining an image quality score; and, in response to the image quality score being below a threshold, generating a notification to a user to obtain an additional inspection image.

Clause 5: The method of any one of Clauses 1-4, further comprising: generating a checklist comprising a set of inspection imaging perspectives corresponding to the respective imaging perspectives of the reference images; and obtaining the set of inspection images in accordance with the checklist.

Clause 6: The method of any one of Clauses 1-5, further comprising: identifying within a reference image, alphanumeric information for the one or more parts of the physical asset; performing optical character recognition (OCR) to obtain data associated with the alphanumeric information; and storing the alphanumeric information within storage.

Clause 7: The method of any one of Clauses 1-6, further comprising: aggregating a set of calculated confidence scores based on comparing asset features and spatial context features of the set of inspection images with their respective matching reference images; and executing one or more aggregation algorithms to determine a status of the one or more parts of the physical asset based on the aggregated confidence scores.

Clause 8: The method of any one of Clauses 1-7, wherein generating the 3D reconstruction further comprises generating a set of fiducial markers having a predetermined distance between each fiducial marker, wherein the set of fiducial markers are associated with a metric scale of the 3D reconstruction.

Clause 9: The method of any one of Clauses 1-8, further comprising: identifying, using a local feature transformer algorithm, one or more discrepancies between the inspection image and the reference image, wherein the one or more discrepancies indicate one or more of a surface texture change, a surface deformation, or a missing feature associated with the part of the physical asset in the inspection image; and, in response to identifying the one or more discrepancies between the inspection image and the reference image, detecting a defect associated with the part.

Clause 10: The method of any one of Clauses 1-9, wherein the asset coordinate system is defined with respect to an invariant point on the physical asset, and the invariant point on the physical asset is associated with one or more of an estimated geometric center of the physical asset or a selected fixed feature on the physical asset.

Clause 11: A processing system, comprising means for performing a method in accordance with any one of Clauses 1-10.

Clause 12: A non-transitory computer-readable medium comprising computer-executable instructions that, when executed by one or more processors of a processing system, cause the processing system to perform a method in accordance with any one of Clauses 1-10.

Clause 13: A computer program product embodied on a computer-readable storage medium comprising code for performing a method in accordance with any one of Clauses 1-10.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
obtaining a set of reference images associated with one or more parts of a physical asset, wherein each reference image of the set of reference images corresponds to a respective imaging perspective;
generating a three-dimensional (3D) reconstruction of the physical asset based on the set of reference images;
defining an asset coordinate system based on mapping the 3D reconstruction of the physical asset to a coordinate frame for the physical asset;
storing, for each reference image, imaging perspective data, asset feature data, and spatial context feature data within a database;
obtaining a set of inspection images associated with the physical asset; and
performing an image inspection, wherein the image inspection comprises:
identifying a matching reference image for an inspection image of the set of inspection images based on calculating a similarity score between the inspection image and a reference image that satisfies an imaging perspective similarity threshold;
calculating a confidence score based on comparing the stored imaging perspective data, asset feature data, and spatial context feature data associated with the matching reference image to the inspection image, wherein a status of a part of the physical asset in the inspection image is indicated by the confidence score satisfying a confidence threshold; and
generating a report based on the calculated confidence score, wherein the report comprises a status indicator for the part of the physical asset.

2. The method of claim 1, wherein calculating the confidence score further comprises:
determining estimated image coordinates corresponding to the part of the physical asset and one or more surrounding structures of the inspection image; and
executing one or more image-matching algorithms to compare the stored imaging perspective data, asset feature data, and spatial context feature data of the matching reference image with the inspection image based on comparing the estimated image coordinates with the matching reference image.

3. The method of claim 1, further comprising generating a localized inspection image by cropping a portion of the inspection image.

4. The method of claim 1, further comprising:
validating the inspection image by determining an image quality score; and in response to the image quality score being below a threshold, generating a notification to a user to obtain an additional inspection image.

5. The method of claim 1, further comprising:
generating a checklist comprising a set of inspection imaging perspectives corresponding to the respective imaging perspectives of the reference images; and
obtaining the set of inspection images in accordance with the checklist.

6. The method of claim 1, further comprising:
identifying within a reference image, alphanumeric information for one or more parts of the physical asset;
performing optical character recognition (OCR) to obtain data associated with the alphanumeric information; and
storing the alphanumeric information within storage.

7. The method of claim 1, further comprising:
aggregating a set of calculated confidence scores based on comparing asset features and spatial context features of the set of inspection images with their respective matching reference images; and
executing one or more aggregation algorithms to determine a status of one or more parts of the physical asset based on the aggregated set of calculated confidence scores.

8. The method of claim 1, wherein generating the 3D reconstruction further comprises generating a set of fiducial markers having a predetermined distance between each fiducial marker, wherein the set of fiducial markers are associated with a metric scale of the 3D reconstruction.

9. The method of claim 1, further comprising:
identifying, using a local feature transformer algorithm, one or more discrepancies between the inspection image and the matching reference image, wherein the one or more discrepancies indicate one or more of a surface texture change, a surface deformation, or a missing feature associated with the part of the physical asset in the inspection image; and
in response to identifying the one or more discrepancies between the inspection image and the matching reference image, detecting a defect associated with the part.

10. The method of claim 1, wherein:
the asset coordinate system is defined with respect to an invariant point on the physical asset, and
the invariant point on the physical asset is associated with one or more of an estimated geometric center of the physical asset or a selected fixed feature on the physical asset.

11. A processing system, comprising:
one or more memories comprising computer-executable instructions; and
one or more processors configured to execute the computer-executable instructions causing the processing system to:
obtain a set of reference images associated with one or more parts of a physical asset, wherein each reference image of the set of reference images corresponds to a respective imaging perspective;
generate a three-dimensional (3D) reconstruction of the physical asset based on the set of reference images;
define an asset coordinate system based on mapping the 3D reconstruction of the physical asset to a coordinate frame for the physical asset;
store, for each reference image, imaging perspective data, asset feature data, and spatial context feature data within a database;
obtain a set of inspection images associated with the physical asset; and
performing an image inspection, wherein in order to perform the image inspection, the one or more processors are further configured to cause the processing system to:
identify a matching reference image for an inspection image of the set of inspection images based on calculating a similarity score between the inspection image and a reference image that satisfies an imaging perspective similarity threshold;
calculate a confidence score based on comparing the stored imaging perspective data, asset feature data, and spatial context feature data associated with the matching reference image to the inspection image, wherein a status of a part of the physical asset in the inspection image is indicated by the confidence score satisfying a confidence threshold; and
generate a report based on the calculated confidence score, wherein the report comprises a status indicator for the part of the physical asset.

12. The processing system of claim 11, wherein to calculate the confidence score, the one or more processors are further configured to cause the processing system to:
determine estimated image coordinates corresponding to the part of the physical asset and one or more surrounding structures of the inspection image; and
execute one or more image-matching algorithms to compare the stored imaging perspective data, asset feature data, and spatial context feature data of the matching reference image with the inspection image based on comparing the estimated image coordinates with the matching reference image.

13. The processing system of claim 11, wherein the one or more processors are further configured to cause the processing system to generate a localized inspection image by cropping a portion of the inspection image.

14. The processing system of claim 11, wherein the one or more processors are further configured to cause the processing system to:
validate the inspection image by determining an image quality score; and
in response to the image quality score being below a threshold, generate a notification to a user to obtain an additional inspection image.

15. The processing system of claim 11, wherein the one or more processors are further configured to cause the processing system to:
generate a checklist comprising a set of inspection imaging perspectives corresponding to the respective imaging perspectives of the reference images; and
obtain the set of inspection images in accordance with the checklist.

16. The processing system of claim 11, wherein the one or more processors are further configured to cause the processing system to:
identify within a reference image, alphanumeric information for one or more parts of the physical asset;
perform optical character recognition (OCR) to obtain data associated with the alphanumeric information; and
store the alphanumeric information within storage.

17. The processing system of claim 11, wherein the one or more processors are further configured to cause the processing system to:
aggregate a set of calculated confidence scores based on comparing asset features and spatial context features of the set of inspection images with their respective matching reference images; and
execute one or more aggregation algorithms to determine a status of one or more parts of the physical asset based on the aggregated set of calculated confidence scores.

18. The processing system of claim 11, wherein to generate the 3D reconstruction the one or more processors are further configured to cause the processing system to generate a set of fiducial markers having a predetermined distance between each fiducial marker, wherein the set of fiducial markers are associated with a metric scale of the 3D reconstruction.

19. The processing system of claim 11, wherein the one or more processors are further configured to cause the processing system to:
identify, using a local feature transformer algorithm, one or more discrepancies between the inspection image and the matching reference image, wherein the one or more discrepancies indicate one or more of a surface texture change, a surface deformation, or a missing feature associated with the part of the physical asset in the inspection image; and
in response to identifying the one or more discrepancies between the inspection image and the matching reference image, detect a defect associated with the part.

20. The processing system of claim 11, wherein:
the asset coordinate system is defined with respect to an invariant point on the physical asset, and
the invariant point on the physical asset is associated with one or more of an estimated geometric center of the physical asset or a selected fixed feature on the physical asset.
